(19) United States
(12) Patent Application Publication
(10) Pub. No.: US 2011/0208636 A1
(43) Pub. Date: Aug. 25, 2011

(54) MATCHING PARTIES TO A TRANSACTION FOR AN AGRICULTURAL COMMODITY

(75) Inventors: Deepa Chandra Bachu, Bangalore (IN); Shaileshkumar Satyanarayan Goyal, Bangalore (IN); Sharath H. Upadhya, Bangalore (IN); Vishnu Nanda, Bangalore (IN); Jayanth Saimani, Bangalore (IN); Narendra Raghothama Mudigal, Bengaluru (IN)

(73) Assignee: INTUIT INC., Mountain View, CA (US)

(21) Appl. No.: 12/933,007

(22) PCT Filed: Sep. 18, 2009
(86) PCT No.: PCT/US2009/057528

§ 371 Date: May 4, 2011

(51) Int. Cl. G06Q 40/00

(52) U.S. Cl. 705/37

(57) ABSTRACT

In general, in one aspect, the invention relates to a method for matching parties to a transaction of an agricultural commodity. The method involves receiving buyer criteria (e.g., purchase quantity, buyer price, transaction location at which to buy the agricultural commodity) sent from a mobile device used by a primary and secondary buyer. The method further involves receiving seller criteria sent from a seller mobile device. The method further involves matching, within a predetermined period of time after receiving the buyer criteria and the seller criteria, the primary and secondary buyer with the seller based on determining that a yield is sufficient to meet the purchase quantity and a transaction location at which to buy the agricultural commodity falls within a number of locations common the primary/secondary buyers and the seller. The method further involves sending the buyer criteria to the seller mobile device using short message service (SMS) format.

### BACKGROUND

In many parts of the world, a farmer may rely on third parties for the provision of services and information required to plant, grow, harvest, and sell a crop. Examples of such information are expected diseases and related treatments, current and future pricing of a crop, and developments in agricultural equipment. Examples of such services are contract farming, transportation, and storage. Without a current knowledge related to information and services associated with various aspects of the farming process, a farmer may experience reduced profits, potentially to the point of having to cease farming because of a lack of revenues.

Transparency to information and services provided by third parties may be difficult to attain. Farmers tend to spend long hours working during critical times in a growing season for a crop, often leaving little free time to research or use technology. Financial resources of a farmer may also be limited, reducing the farmer's ability to buy equipment and access to information and services that may help a farmer make better decisions with respect to a crop. In some cases, certain information and services may not exist or may be unavailable. For example, a large number of farmers may live in relatively close proximity and yet not have any resources available to them to discover the best market price for their crop. Instead, these farmers must take their crop, often in the form of perishable goods, to one of a number of local markets and accept whatever price a buyer offers.

### SUMMARY

In general, in one aspect, the invention relates to a method for matching parties to a transaction of an agricultural commodity. The method involves receiving a number of buyer criteria, where each of the number of buyer criteria is sent from a mobile device used by one of a number of buyers of the agricultural commodity, where the number of buyers includes a primary buyer and a secondary buyer, and where each of the number of buyer criteria includes a purchase quantity, a buyer price, and a transaction location at which to buy the agricultural commodity. The method further involves receiving seller criteria for the agricultural commodity sent from a seller mobile device, where the seller criteria includes a sales quantity, a yield from an area of land used to produce the agricultural commodity, and a number of locations at which to sell the agricultural commodity. The method further involves matching, within a predetermined period of time after receiving the number of buyer criteria and the seller criteria, each of the number of buyers with the seller based on determining that the yield is sufficient to meet the purchase quantity and the transaction location at which to buy the agricultural commodity falls within the number of locations. The method further involves sending the number of buyer criteria to the seller mobile device using short message service (SMS) format.

In general, in one aspect, the invention relates to a method for matching a seller to a buyer for transacting an agricultural commodity. The method involves sending, using a seller mobile device, seller criteria for the agricultural commodity, where the seller criteria includes a sales quantity, a yield from an area of land used to produce the agricultural commodity, and a number of locations at which to sell the agricultural commodity. The method further involves, within a predetermined period of time after sending the seller criteria, receiving a number of buyer criteria on the mobile device in short message service (SMS) format, based on determining that the yield is sufficient to meet a purchase quantity and a transaction location at which to sell the agricultural commodity falls within the number of locations, where each of the number of buyer criteria is sent from a mobile device used by one of a number of buyers of the agricultural commodity, where each of the number of buyer criteria includes the purchase quantity, a buyer price, and the transaction location at which to buy the agricultural commodity, and where the number of buyers includes a primary buyer and a secondary buyer. The method further involves evaluating each of the number of buyer criteria and selecting a buyer criteria of the primary buyer from the number of buyer criteria. The method further involves contacting, using the seller mobile device, the primary buyer using contact information provided by the primary buyer to execute the transaction of the agricultural commodity at a primary transaction price based on the buyer criteria of the primary buyer.

In general, in one aspect, the invention relates to a system for matching parties to a transaction of an agricultural commodity. The system includes a storage repository configured to store seller criteria and a number of buyer criteria. The system also includes a processor of a central server configured to access the storage repository and execute software instructions stored in memory for receiving a number of buyer criteria, where each of the number of buyer criteria is sent from a mobile device used by one of a number of buyers of the agricultural commodity, where the number of buyers includes a primary buyer and a secondary buyer, and where each of the number of buyer criteria includes a purchase quantity, a buyer price, and a transaction location at which to buy the agricultural commodity. The processor of the central server is also configured to execute software instructions stored in memory for receiving seller criteria for the agricultural commodity sent from a seller mobile device, where the seller criteria includes a sales quantity, a yield from an area of land used to produce the agricultural commodity, and a number of locations at which to sell the agricultural commodity. The processor of the central server is further configured to execute software instructions stored in memory for matching, within a predetermined period of time after receiving the number of buyer criteria and the seller criteria, each of the number of buyers with the seller based on determining that the yield is sufficient to meet the purchase quantity and the transaction location at which to buy the agricultural commodity falls within the number of locations. The processor of the central server is further configured to execute software instructions stored in memory for sending the number of buyer criteria to the seller mobile device using short message service (SMS) format.

In general, in one aspect, the invention relates to a computer readable medium comprising instructions executable by a processor to perform a method for matching parties to a transaction of an agricultural commodity. The method involves receiving a number of buyer criteria, where each of the number of buyer criteria is sent from a mobile device used by one of a number of buyers of the agricultural commodity, where the number of buyers includes a primary buyer and a secondary buyer, and where each of the number of buyer criteria includes a purchase quantity, a buyer price, and a transaction location at which to buy the agricultural commodity. The method further involves receiving seller criteria for the agricultural commodity sent from a seller mobile device, where the seller criteria includes a sales quantity, a yield from an area of land used to produce the agricultural commodity, and a number of locations at which to sell the agricultural commodity. The method further involves matching, within a predetermined period of time after receiving the number of buyer criteria and the seller criteria, each of the number of buyers with the seller based on determining that the yield is sufficient to meet the purchase quantity and the transaction location at which to buy the agricultural commodity falls within the number of locations. The method further involves sending the number of buyer criteria to the seller mobile device using short message service (SMS) format.

In general, in one aspect, the invention relates to a computer readable medium comprising instructions executable by a processor to perform a method for matching a seller to a buyer for transacting an agricultural commodity. The method involves sending, using a mobile device, seller criteria of the agricultural commodity, the seller criteria comprising a sales quantity, a category, and a number of locations at which to sell the agricultural commodity, where the number of locations includes the location from each of the number of buyer criteria, and where the category includes the one of the number of ranges corresponding to an area of land used to produce the agricultural commodity. The method further involves, within a predetermined period of time of sending the seller criteria, receiving on the mobile device in short message service format, based on matching to the seller criteria, a number of buyer criteria associated with a number of buyers, where each of the number of buyer criteria includes contact information, the category, a buyer price, and a location at which to buy the agricultural commodity, where the number of buyers includes a primary buyer and a secondary buyer, where the category includes one of a number of a ranges corresponding to a purchase quantity, and where matching to the seller criteria includes matching each of the number of buyers with the seller based on the category and the number of locations. The method further involves evaluating each of the number of buyer criteria and selecting buyer criteria associated with the primary buyer. The method further involves contacting, using the mobile device, the primary buyer using the contact information to execute the transaction of the agricultural commodity at a transaction price based on the buyer criteria of the primary buyer.

### BRIEF DESCRIPTION OF DRAWINGS

FIG. 1 shows a system in accordance with one or more embodiments of the invention.

FIGS. 2A and 2B show an example data structure for registration and criteria, respectively, in accordance with one or more embodiments of the invention.

FIGS. 3 and 4 show flowcharts for matching parties to a transaction for an agricultural commodity in accordance with one or more embodiments of the invention.

FIGS. 5A and 5B show an example of matching parties to a transaction for an agricultural commodity in accordance with one or more embodiments of the invention.

FIGS. 6A and 6B show an example of registration information and criteria, respectively, used for matching parties to a transaction for an agricultural commodity in accordance with one or more embodiments of the invention.

FIG. 7 shows a graphical depiction of a matching process for matching parties to a transaction for an agricultural commodity in accordance with one or more embodiments of the invention.

FIGS. 8A and 8B shows examples of criteria being sent for matching parties to a transaction for an agricultural commodity in accordance with one or more embodiments of the invention.

FIGS. 9A and 9B show examples results for matching parties to a transaction for an agricultural commodity in accordance with one or more embodiments of the invention.

FIG. 10 shows an example of an output display providing weather information likely to impact matching parties to a transaction for an agricultural commodity in accordance with one or more embodiments of the invention.

FIG. 11 shows an example of an output display providing viability information of an agricultural commodity likely to impact matching parties to a transaction for the agricultural commodity in accordance with one or more embodiments of the invention.

FIG. 12 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide for matching parties to a transaction for an agricultural commodity. More specifically, one or more embodiments of the invention provide for using criteria associated with each party to match parties to the transaction for the agricultural commodity using a mobile device. One or more embodiments of the invention also provide for receiving criteria associated with a party using the mobile device. A transaction is executed between a buyer and a seller. More than one buyer and/or more than one seller may be referred to as entities, parties, counterparties, or any other suitable designation.

In one or more embodiments of the invention, an agricultural commodity may be a crop grown by a farmer, including but not limited to corn, soy, cotton, strawberries, bananas, avocados, or rice. The agricultural commodity may be perishable or non-perishable. An agricultural commodity may also be a product or service related to a crop grown by a farmer, including but not limited to fertilizer, pesticide, equipment, contract farming, storage, and transportation services. Further, an agricultural commodity may include other agriculturally-related products or services, including but not limited to livestock, feed for livestock, eggs, feedstock for ethanol and/or biodiesel plants, farm equipment repair, and cut flowers. An agricultural commodity may be more specific to a species or quality grade. For example, different species of rice may include, but not be limited to, medium rice, course rice, and fine rice. As a further example, different grades of beef may include, but not be limited to, prime, choice, select, standard, commercial, utility, cutter, and canner.

The terms “primary” and “secondary” used herein may merely designate different buyers and/or sellers. When the words “primary” and “secondary” are used, other entities (e.g., tertiary) may also exist, even if not expressly designated. The word “primary” may mean that the primary entity (e.g., buyer, seller) is offering, in view of a counterparty of a potential transaction, the most attractive terms for the agricultural commodity. The word “secondary” may mean that the secondary entity (e.g., buyer, seller) is offering, in view of a counterparty of a potential transaction, the second most attractive terms, next to the primary entity, for the agricultural commodity. Similarly, the words “first” and “second” used herein may merely designate different entities as opposed to suggesting an order or preference. When the words “first” and “second” are used, other entities (e.g., third, fourth) may also exist, even if not expressly designated.

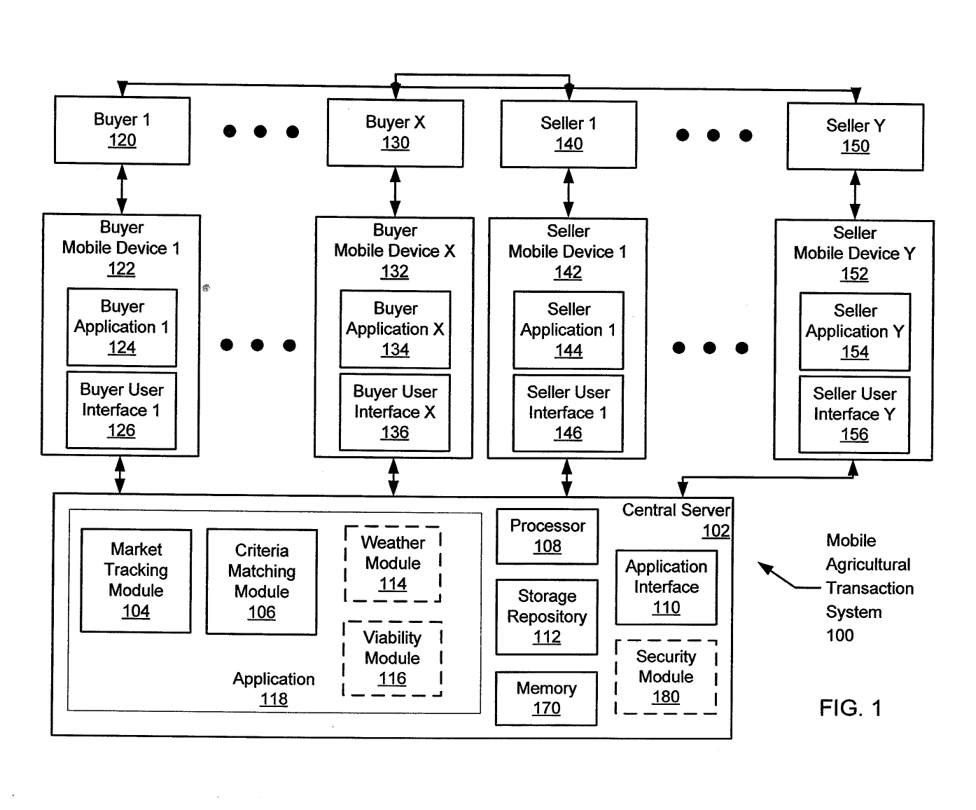

FIG. 1 shows a mobile agricultural transaction system (100) for matching parties to a transaction for an agricultural commodity in accordance with one or more embodiments of the invention. The mobile agricultural transaction system (100) includes one or more buyers (e.g., buyer 1 (120), buyer X (130)), each with a buyer mobile device (e.g., buyer mobile device 1 (122), buyer mobile device X (132)), one or more sellers (e.g., seller 1 (140), seller Y (150)), each with a seller mobile device (e.g., seller mobile device 1 (142), seller mobile device Y (152)), and a central server (102). Each buyer mobile device (e.g., buyer mobile device 1 (122), buyer mobile device X (132)) includes a buyer application (e.g., buyer application 1 (124), buyer application X (134)) and a buyer user interface (e.g., buyer user interface 1 (126), buyer user interface X (136)). Each seller mobile device (e.g., seller mobile device 1 (142), seller mobile device Y (152)) includes a seller application (e.g., seller application 1 (144), seller application Y (154)) and a seller user interface (e.g., seller user interface 1 (146), seller user interface Y (156)). The central server (102) includes an application (118), a processor (108), an application interface (110), a storage repository (112), and memory (170). The central server (102) may optionally include a security module (180). The application (118) of the central server (102) includes a market tracking module (104) and a criteria matching module (106). The application (118) may optionally include a weather module (114) and a viability module (116). Each of these components is described with respect FIG. 1 below.

The mobile agricultural transaction system (100) may be a separate system, a plug-in of another system, a web-based service, a service residing on a desktop computer, a framework for other platforms to utilize, or configured in any other suitable way. One of ordinary skill in the art will appreciate that embodiments of the invention are not limited to the configuration shown in FIG. 1.

In one or more embodiments of the Invention, the buyer (e.g., buyer 1 (120), buyer X (130)) is an entity of some kind (e.g., a person, a robot, automated component, etc.) attempting to buy an agricultural commodity. A buyer (e.g., buyer 1 (120), buyer X (130)) of one agricultural commodity (e.g., corn) may be a seller (e.g., seller 1 (140), seller Y (150), as defined below) of a different agricultural commodity (e.g., fertilizer). In one or more embodiments of the invention, a buyer (e.g., buyer 1 (120), buyer X (130)) may be an entity with a direct use for the crop. A buyer (e.g., buyer 1 (120), buyer X (130)) may also be an aggregation of buyers, a broker, an agent, or any other entity with an interest in purchasing a crop.

In one or more embodiments of the invention, the seller (e.g., seller 1 (140), seller Y (150)) is an entity of some kind (e.g., a person, a robot, automated component, etc.) attempting to sell an agricultural commodity. A seller (e.g., seller 1 (140), seller Y (150)) of one agricultural commodity (e.g., wheat) may be a buyer (e.g., buyer 1 (120), buyer X (130)) of a different agricultural commodity (e.g., transportation services). In one or more embodiments of the invention, a seller (e.g., seller 1 (140), seller Y (150)) may be a farmer who grows the crop for sale. A seller (e.g., seller 1 (140), seller Y (150)) may also be an aggregation of sellers, a broker, an agent, or some other entity with an interest in selling a crop.

In one or more embodiments of the invention, the buyer mobile device (e.g., buyer mobile device 1 (122), buyer mobile device X (132)) is operated by a corresponding buyer (e.g., buyer 1 (120), buyer X (130)). The buyer mobile device (e.g., buyer mobile device 1 (122), buyer mobile device X (132)) may be any device configured to send, store, and/or receive data over a network. Specifically, the buyer mobile device (e.g., buyer mobile device 1 (122), buyer mobile device X (132)) may be configured to send output to, and receive input from, the central server (102), a different buyer mobile device (e.g., buyer mobile device 1 (122), buyer mobile device X (132)), and/or a seller mobile device (e.g., seller mobile device 1 (142), seller mobile device Y (152)). In one or more embodiments of the invention, the buyer mobile device (e.g., buyer mobile device 1 (122), buyer mobile device X (132)) is configured to send one or more criterion of a buyer (e.g., buyer 1 (120), buyer X (130)) attempting to buy an agricultural commodity.

The buyer mobile device (e.g., buyer mobile device 1 (122), buyer mobile device X (132)) may also be any device configured to require authentication of the buyer (e.g., buyer 1 (120), buyer X (130)) before granting access to the buyer mobile device (e.g., buyer mobile device 1 (122), buyer mobile device X (132)), receiving information, and/or sending information. Examples of a buyer mobile device (e.g., buyer mobile device 1 (122), buyer mobile device X (132)) may include, but are not limited to, a smart device, a desktop computer, a laptop computer, a smart phone, a mobile phone, and a personal digital assistant (PDA).

In one or more embodiments of the invention, the buyer application (e.g., buyer application 1 (124), buyer application X (134)) of the buyer mobile device (e.g., buyer mobile device 1 (122), buyer mobile device X (132)) is configured to send and receive messages in short message service (SMS) format. The buyer application (e.g., buyer application 1 (124), buyer application X (134)) may also be configured to send and receive information in other formats, including but not limited to electronic mail, an automated call, voice call, any other suitable format, or any suitable combination thereof.

In one or more embodiments of the invention, the buyer user interface (e.g., buyer user interface 1 (126), buyer user interface X (136)) of the buyer mobile device (e.g., buyer mobile device 1 (122), buyer mobile device X (132)) includes a display and a keyboard. The buyer user interface (e.g., buyer user interface 1 (126), buyer user interface X (136)) may also include a speaker, a microphone, a touch screen, any other component that allows the user to communicate using the buyer mobile device (e.g., buyer mobile device 1 (122), buyer mobile device X (132)), or any suitable combination thereof. The keyboard of the buyer user interface (e.g., buyer user interface 1 (126), buyer user interface X (136)) may be a numeric keypad that is configured to allow the buyer (e.g., buyer 1 (120), buyer X (130)) to enter text in the form of numbers and/or letters.

In one or more embodiments of the invention, the seller mobile device (e.g., seller mobile device 1 (142), seller mobile device Y (152)) is operated by a seller (e.g., seller 1 (140), seller Y (150)). The seller mobile device (e.g., seller mobile device 1 (142), seller mobile device Y (152)) may be any device configured to send, store, and/or receive data over a network. Specifically, the seller mobile device (e.g., seller mobile device 1 (142), seller mobile device Y (152)) may be configured to send output to, and receive input from, the central server (102), a different seller mobile device (e.g., seller mobile device 1 (142), seller mobile device Y (152)), and/or a buyer mobile device (e.g., buyer mobile device 1 (122), buyer mobile device X (132)). In one or more embodiments of the invention, the seller mobile device (e.g., seller mobile device 1 (142), seller mobile device Y (152)) is configured to send one or more criterion of a seller (e.g., seller 1 (140), seller Y (150)) attempting to buy an agricultural commodity.

The seller mobile device (e.g., seller mobile device 1 (142), seller mobile device Y (152)) may also be any device configured to require authentication of the seller (e.g., seller 1 (140), seller Y (150)) before granting access to the seller mobile device (e.g., seller mobile device 1 (142), seller mobile device Y (152)), receiving information, and/or sending information. Examples of a seller mobile device (e.g., seller mobile device 1 (142), seller mobile device Y (152)) may include, but are not limited to, a smart device, a desktop computer, a laptop computer, a smart phone, a mobile phone, and a personal digital assistant (PDA).

In one or more embodiments of the invention, the seller application (e.g., seller application 1 (144), seller application Y (154)) of the seller mobile device (e.g., seller mobile device 1 (142), seller mobile device Y (152)) is configured to send and receive messages in short message service (SMS) format. The seller application (e.g., seller application 1 (144), seller application Y (154)) of the seller mobile device (e.g., seller mobile device 1 (142), seller mobile device Y (152)) may also be configured to send and receive information in other formats, including but not limited to electronic mail, an automated call, voice call, any other suitable format, or any suitable combination thereof.

In one or more embodiments of the invention, the seller user interface (e.g., seller user interface 1 (146), seller user interface Y (156)) includes a display and a keyboard. The seller user interface (e.g., seller user interface 1 (146), seller user interface Y (156)) may also include a speaker, a microphone, a touch screen, any other component that allows the user to communicate using the seller mobile device (e.g., seller mobile device 1 (142), seller mobile device Y (152)), or any suitable combination thereof. The keyboard of the seller user interface (e.g., seller user interface 1 (146), seller user interface Y (156)) may be a numeric keypad that is configured to allow the seller (e.g., seller 1 (140), seller Y (150)) to enter text in the form of numbers and/or letters.

In one or more embodiments of the invention, the buyer mobile device (e.g., buyer mobile device 1 (122), buyer mobile device X (132)) and seller mobile device (e.g., seller mobile device 1 (142), seller mobile device Y (152)) communicate with the central server (102) via a network (not shown). The network may be a wide area network (WAN), a metropolitan area network (MAN), a local area network (LAN), a public network (such as the Internet or World Wide Web), a wireless network, a telephone network, or any suitable combination thereof. Further, the network may include one or more networks interconnected by other network types (e.g., distinct LANs connected by one or more WANs).

In one or more embodiments of the invention, the processor (108) of the central server (102) is configured to execute instructions to operate the application (118) and its components (e.g., market tracking module (104), criteria matching module (106)), the application interface (110), and the storage repository (112).

In one or more embodiments of the invention, the central server (102) is configured to communicate with the buyer mobile device (e.g., buyer mobile device 1 (122), buyer mobile device X (132)) and the seller mobile device (e.g., seller mobile device 1 (142), seller mobile device Y (152)). More specifically, the application interface (110) of the central server (102) may be configured to communicate with the buyer application (e.g., buyer application 1 (124), buyer application X (134)) and the seller application (e.g., seller application 1 (144), seller application Y (154)). The application interface (110) may be, or may contain a form of, a web-based communication device that is capable of communicating with the buyer application (e.g., buyer application 1 (124), buyer application X (134)) and the seller application (e.g., seller application 1 (144), seller application Y (154)). The application interface (110) may also communicate with other devices and/or data sources with which to send and receive information.

In one or more embodiments of the invention, each buyer mobile device (e.g., buyer mobile device 1 (122), buyer mobile device X (132)) and seller mobile device (e.g., seller mobile device 1 (142), seller mobile device Y (152)) is identified before communication is initiated by the application interface (110) of the central server (102). In some cases, the central server (102) may be configured to interact with a number of buyer mobile devices (e.g., buyer mobile device 1 (122), buyer mobile device X (132)) and seller mobile devices (e.g., seller mobile device 1 (142), seller mobile device Y (152)), where each particular mobile device may be identified prior to communication being initiated by the application interface (110). A particular buyer mobile device (e.g., buyer mobile device 1 (122), buyer mobile device X (132)) and/or seller mobile device (e.g., seller mobile device 1 (142), seller mobile device Y (152)) may also be identified and/or modified for the application interface (110) during runtime. The application interface (110) may be configured to interact with multiple buyer mobile devices (e.g., buyer mobile device 1 (122), buyer mobile device X (132)) and seller mobile devices (e.g., seller mobile device 1 (142), seller mobile device Y (152)) simultaneously.

In one or more embodiments of the invention, the central server (102) is configured to store information received from the buyer mobile device(s) (e.g., buyer mobile device 1 (122), buyer mobile device X (132)) and seller mobile device(s) (e.g., seller mobile device 1 (142), seller mobile device Y (152)) in a storage repository (112). The storage repository (112) may be any device or medium capable of storing profile information. For example, the storage repository (112) may be one or more databases, a directory service, one or more flat files, a spreadsheet, an extensible markup language (XML) file, a hard disk, an optical drive such as a compact disk drive or digital video disk (DVD) drive, persistent storage, or any other suitable data repository. In one or more embodiments of the invention, the storage repository (112) may be hosted on a data server (not shown) maintained by a third party. Further, the storage repository (112) may be directly connected to the central server (102) or may be connected to the central server (102) via a network (not shown). The storage repository (112) may be configured to store registration information received for buyers (e.g., buyer 1 (120), buyer X (130)) and sellers (e.g., seller 1 (140), seller Y (150)). The storage repository (112) may also be configured to store criteria received for buyers (e.g., buyer 1 (120), buyer X (130)) and sellers (e.g., seller 1 (140), seller Y (150)). In the event that a buyer (e.g., buyer 1 (120), buyer X (130)) and/or seller (e.g., seller 1 (140), seller Y (150)) submits a revised criteria, the storage repository (112) may be configured to delete the earlier criteria. Alternatively, the storage repository (112) may be configured to archive the earlier criteria.

In one or more embodiments of the invention, the memory (170) of the central server (102) is configured to store software instructions for matching parties to a transaction of an agricultural commodity. The memory (170) may be one of a variety of memory devices, including but not limited to random access memory (RAM), read-only memory (ROM), cache memory, and flash memory. The memory (170) may be further configured to serve as back-up storage for information stored in the storage repository (112).

In one or more embodiments of the invention, the application (118) of the central server (102) is configured to track the pricing of an agricultural commodity. Specifically, the market tracking module (104) of the application (118) may be configured to retrieve historical pricing information for an agricultural commodity stored in the storage repository (112) and predict a future price for the agricultural commodity. More specifically, the market tracking module (104) is configured to predict a future price for an agricultural commodity using real-time data (or as close to real-time data as possible). In one or more embodiments of the invention, the market tracking module (104) predicts the future price of the agricultural commodity based on other information associated with historical transactions that may be stored in the storage repository (112), including but not limited to the quality of the agricultural commodity, the quantity of each of the transactions from which the historical pricing information was retrieved, and the location of the transaction. The market tracking module (104) may also use general information that may affect the price of the agricultural commodity, such as information from the weather module (114) and the viability module (116), each described below, to predict the future price for the agricultural commodity.

In one or more embodiments of the invention, the application (118) of the central server (102) is configured to match one or more buyers (e.g., buyer 1 (120), buyer X (130)) with a seller (e.g., seller 1 (140), seller Y (150)). Specifically, the criteria matching module (106) of the application (118) may be configured to match the criteria of a seller (e.g., seller 1 (140), seller Y (150)) with the criteria of one or more buyers (e.g., buyer 1 (120), buyer X (130)). In one or more embodiments of the invention, the criteria matching module (106) is also configured to send the results of criteria matching to the application interface (110) for transmission to the seller mobile device (e.g., seller mobile device 1 (142), seller mobile device Y (152)).

Optionally, in one or more embodiments of the invention, the application (118) of the central server (102) is configured to process data related to the weather. Specifically, the weather module (114) of the application (118) may be configured to receive weather-related data from the storage repository (112) and/or the application interface (110). In one or more embodiments, the weather module (114) may obtain weather-related data from an external weather database and import the data into the central server. The weather module (114) may also be configured to process the weather-related data to generate weather forecasts and other weather information. In one or more embodiments of the invention, the weather forecasts and other weather information that are generated by the weather module (114) may be for specific geographic areas.

In one or more embodiments of the invention, the output generated by the weather module (114) is sent to the application interface (110) for delivery to a particular buyer mobile device (e.g., buyer mobile device 1 (122), buyer mobile device X (132)) and/or a particular seller mobile device (e.g., seller mobile device 1 (142), seller mobile device Y (152)) corresponding to a buyer (e.g., buyer 1 (120), buyer X (130)) and/or seller (e.g., seller 1 (140), seller Y (150)) that are located in a geographic area that is the subject of the weather information. The output of the weather module (114) may be configured according to a request received from a particular buyer mobile device (e.g., buyer mobile device 1 (122), buyer mobile device X (132)) and/or a particular seller mobile device (e.g., seller mobile device 1 (142), seller mobile device Y (152)). The output generated by the weather module (114) may also be sent to the application interface (110) for delivery to all buyer mobile devices (e.g., buyer mobile device 1 (122), buyer mobile device X (132)) and/or all seller mobile devices (e.g., seller mobile device 1 (142), seller mobile device Y (152)).

Optionally, in one or more embodiments of the invention, the application (118) of the central server (102) is configured to process data related to the viability of an agricultural commodity. Specifically, the viability module (116) of the application (118) may be configured to receive data related to the viability of an agricultural commodity from the storage repository (112) and/or the application interface (110). The viability module (116) may also be configured to process the data related to the viability of an agricultural commodity and generate an output that may include various information regarding the viability of an agricultural commodity, including but not limited to forecasting a disease that may affect the agricultural commodity in a future growing season, recommending ways to combat such a disease, recommending that a farmer grow a different commodity in a future growing season. Information regarding viability of an agricultural commodity may also include geographical information, such as the location where the seller (e.g. the farmer) is producing the agricultural commodity and the location where the buyer purchases (or seeks to purchase) the agricultural commodity (i.e. transaction location). Such geographical information allows viability to be tracked and trends determined within a geographical area (city, country, state, country, continent, ecosystem, or other definable area).

In one or more embodiments of the invention, the output generated by the viability module (116) is sent to the application interface (110) for delivery to a particular buyer mobile device (e.g., buyer mobile device 1 (122), buyer mobile device X (132)) and/or a particular seller mobile device (e.g., seller mobile device 1 (142), seller mobile device Y (152)) corresponding to a buyer (e.g., buyer 1 (120), buyer X (130)) and/or seller (e.g., seller 1 (140), seller Y (150)) with an interest in the agricultural commodity that is the subject of the viability information. The output of the weather module (114) may be configured according to a request received from a particular buyer mobile device (e.g., buyer mobile device 1 (122), buyer mobile device X (132)) and/or a particular seller mobile device (e.g., seller mobile device 1 (142), seller mobile device Y (152)). The output generated by the viability module (116) may also be sent to the application interface (110) for delivery to all buyer mobile devices (e.g., buyer mobile device 1 (122), buyer mobile device X (132)) and/or all seller mobile devices (e.g., seller mobile device 1 (142), seller mobile device Y (152)).

In one or more embodiments of the invention, the central server (102) is optionally configured to verify that a buyer (e.g., buyer 1 (120), buyer X (130)) and/or a seller (e.g., seller 1 (140), seller Y (150)) is authorized to access the central server (102). More specifically, the security module (180) may be configured to authenticate the buyer (e.g., buyer 1 (120), buyer X (130)) and/or seller (e.g., seller 1 (140), seller Y (150)) before allowing the buyer (e.g., buyer 1 (120), buyer X (130)) and/or seller (e.g., seller 1 (140), seller Y (150)) to access the central server (180). Authenticating the buyer (e.g., buyer 1 (120), buyer X (130)) and/or seller (e.g., seller 1 (140), seller Y (150)) may occur in a variety of ways, including but not limited to a personal identification number, voice recognition, a password, biometric authentication, any other suitable authentication mechanism, or any combination thereof.

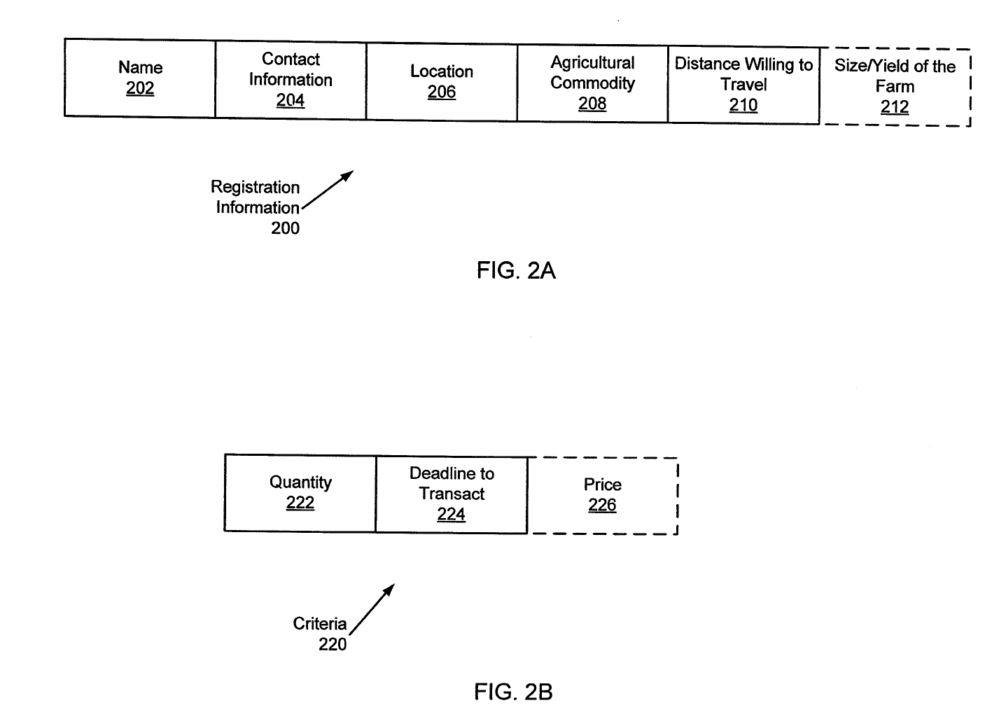

FIGS. 2A and 2B each show a data structure used for matching parties to a transaction for an agricultural commodity in accordance with one or more embodiments of the invention. The data structure may be stored in the storage repository of the central server, as described above with respect to FIG. 1. While the fields in these data structures are presented and described sequentially, one of ordinary skill will appreciate that some or all of the fields may be organized in different orders, or may be combined or omitted. In addition, a person of ordinary skill in the art will appreciate that other fields, omitted in FIGS. 2A and 2B, may be included in these data structures. Accordingly, the specific arrangement of fields shown in FIGS. 2A and 2B should not be construed as limiting the scope of the invention.

FIG. 2A shows an example of a data structure for registration information (200) received from a buyer and/or seller in accordance with one or more embodiments of the invention. The registration information (200) may include a number of components (e.g., name (202), contact information (204)). In one or more embodiments of the invention, a name (202) identifies an entity. The name (202) may be for an individual or a company. The name (202) may be for a farmer, an agent, a broker, an aggregator, a direct buyer, a direct seller, a logistics provider, or some other entity with an interest in transacting for an agricultural commodity. In one or more embodiments of the invention, contact information (204) provides information as to how an entity may be contacted. The contact information (204) may be a phone number, an email address, a name tied to a messaging service, a web address, a fax number, or some other suitable contact information. More than one contact information (204) (e.g., primary and secondary contact information) may be received for an entity.

In one or more embodiments of the invention, a location (206) identifies a geographic location from which the entity operates. The location (206) may be a geographic location of a farm, a marketplace where agricultural commodity transactions take place, a storage facility, or some other suitable location. The location (206) may be entered in a variety of ways, including but not limited to a street address, an intersection of streets, a city, a state, a zip code, latitude/longitude coordinates, a location specified in terms relative to a landmark or another location, any other identification of a location, or any suitable combination thereof. More than one location (206) may be received for an entity, for example in cases where the entity owns multiple farms growing the same agricultural commodity in different geographic locations. In one or more embodiments of the invention, an agricultural commodity (208) identifies the agricultural commodity in which the entity participates. The agricultural commodity (208) may be a crop, a service, a fertilizer, or some other marketable commodity that is related to agriculture.

Continuing with FIG. 2A, in one or more embodiments of the invention, a distance willing to travel (210) identifies where and/or how far the entity is willing to travel in order to execute a transaction for an agricultural commodity. The distance willing to travel (210) may be a distance from a geographic location, including but not limited to the location (206) described above. The distance willing to travel (210) may also be a single geographic location, including but not limited to the location (206) described above. The distance willing to travel (210) may also be a series of physical locations. In one or more embodiments of the invention, a size/yield of the farm (212) is a field that appears only for sellers and specifies the area of land used to produce the agricultural commodity. The size/yield of the farm (212) may be a mandatory field for a seller but an optional one for a buyer. The size/yield of the farm (212) may be depicted in acres, square feet, square meters, or some other suitable measurement of an area. Alternatively, the size/yield of the farm (212) may be depicted in bushels, gallons, pounds, or some other suitable measurement of a quantity of an agricultural commodity that may be produced from the farm. The size/yield of the farm (212) may be used to estimate a quantity of an agricultural commodity that a seller has to sell. In one or more embodiments of the invention, the size/yield of the farm (212) may be used to categorize the seller when matching parties to the agricultural transaction. One skilled in the art will appreciate that other fields or categories may exist with the registration information, such as a frequency for sending transaction information.

FIG. 2B shows an example of a data structure for criteria (220) received from a buyer and/or seller in accordance with one or more embodiments of the invention. The registration information (200) may include a number of components (e.g., quantity (222), deadline to transact (224), price (226)). In one or more embodiments of the invention, a quantity (222) identifies an amount of an agricultural commodity that the entity is willing to transact. The quantity (222) may be in a unit of measure that is consistent with the agricultural commodity. For example, if the agricultural commodity is corn, then the quantity (222) may be expressed in terms of U.S. bushels, Imperial bushels, pecks, cubic inches, liters, or some other suitable unit of measure for corn. Alternatively, if the agricultural commodity is a combine harvester, then the quantity (222) may be expressed in terms of a quantity or number of combine. A quantity (222) of an agricultural commodity offered for sale may be called a sales quantity, and a quantity (222) of an agricultural commodity being sought for purchase may be called a purchase quantity. In one or more embodiments of the invention, the quantity (222) may be used to categorize the buyer (for example, using ranges of volumes) when matching parties to the agricultural transaction.

In one or more embodiments of the invention, a deadline to transact (224) identifies an amount of time within which the entity is willing to transact. The deadline to transact (224) may be a day and/or time. The deadline to transact (224) may also be a start day/time and an end day/time, in the event that the entity wants to submit criteria for a future time rather than have the criteria considered immediately by potential counterparties. In one or more embodiments of the invention, a price (226) is an optional field indicating a bid of a buyer (i.e., a buyer price) or an offer of a seller (i.e., a seller price) of the agricultural commodity. The price (226) may be in a currency. In one or more embodiments of the invention, the currency of the price (226) is one that is prevalent and/or known in a geographic location of the potential transaction. The price (226) may be a required field for a buyer and an optional field for a seller.

Those skilled in the art will appreciate that the data structures shown in FIGS. 2A and 2B may be combined into a single data structure for a buyer or a seller. In addition, the data structure may be a table, a linked list, an array, or any other suitable data structure for storing data.

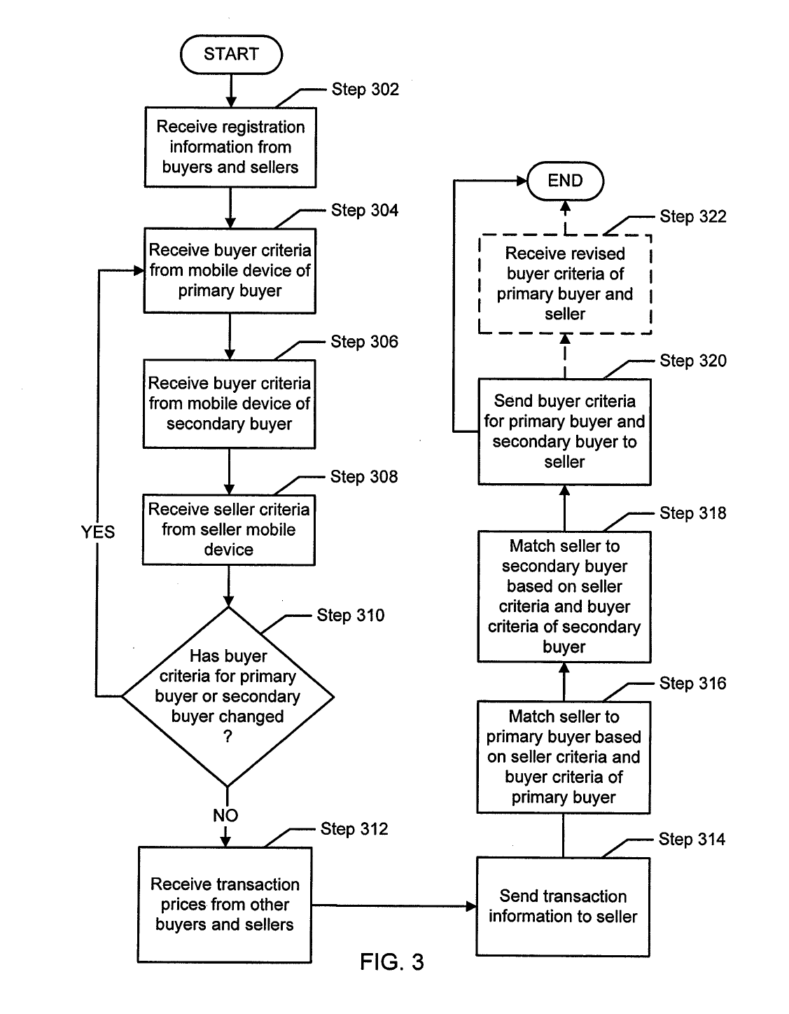

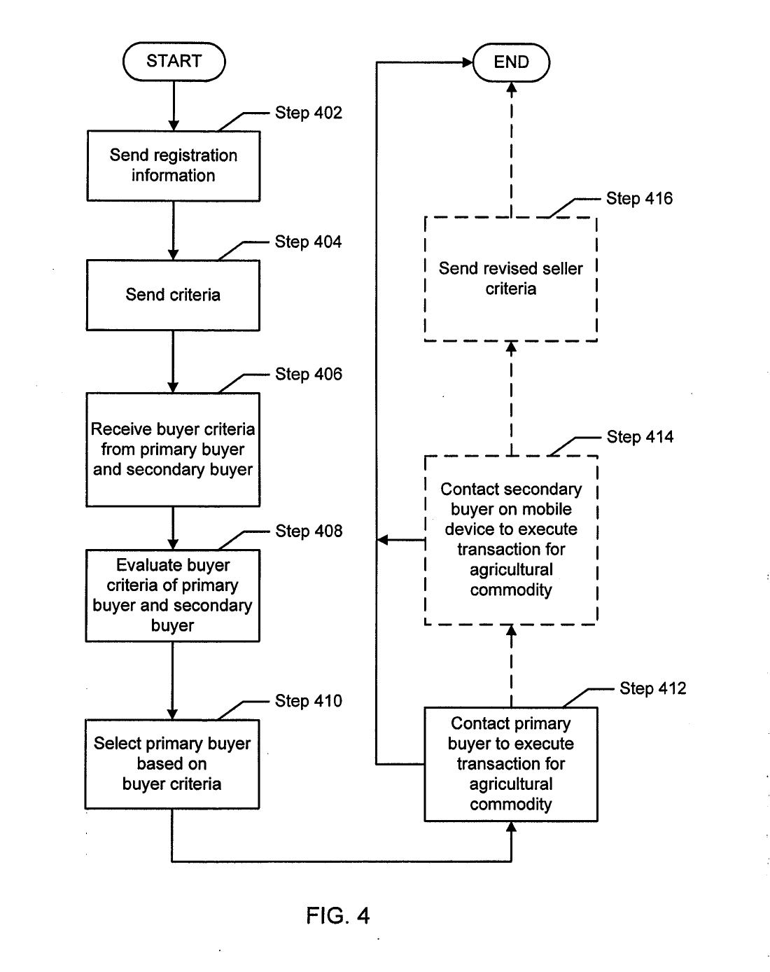

FIGS. 3 and 4 show flowcharts for a method for matching parties to a transaction for an agricultural commodity in accordance with one or more embodiments of the invention. While the various steps in this flowchart are presented and described sequentially, one of ordinary skill will appreciate that some or all of the steps may be executed in different orders, may be combined or omitted, and some or all of the steps may be executed in parallel. In addition, a person of ordinary skill in the art will appreciate that other steps, omitted in FIGS. 3 and 4, may be included in this flowchart. Accordingly, the specific arrangement of steps shown in FIGS. 3 and 4 should not be construed as limiting the scope of the invention.

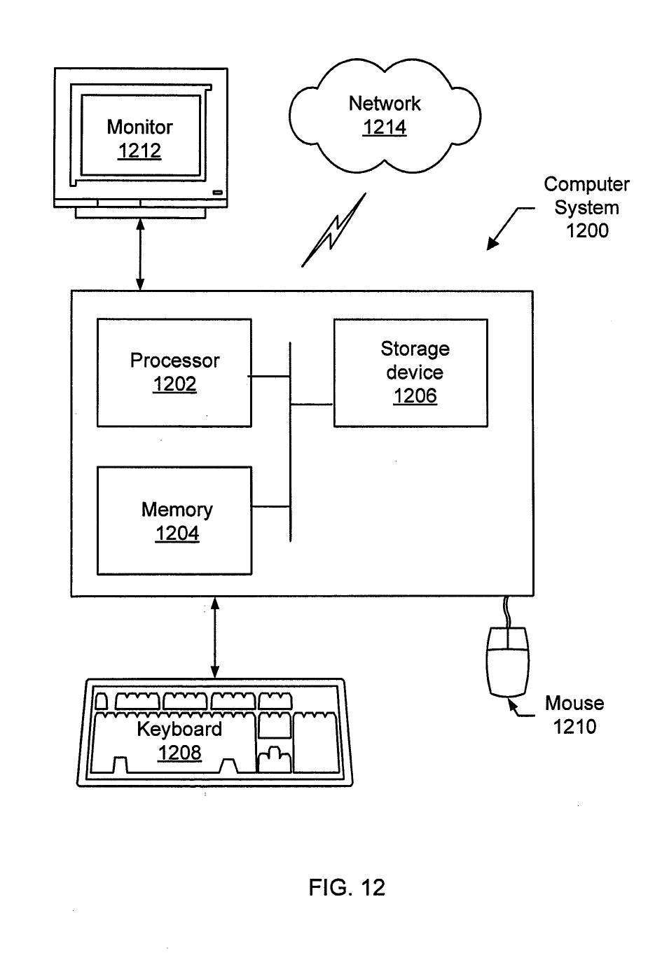

FIG. 3 shows a flowchart of the method for matching parties to a transaction for an agricultural commodity from the perspective of the system (i.e., the central server, as described above with respect to FIG. 1). In step 302, registration information is received from buyers and sellers. A buyer may be a direct buyer, an aggregator, a broker, an agent, a logistics provider, or some other entity with an interest in purchasing the agricultural commodity. A seller may be a farmer, an aggregator, a broker, an agent, a logistics provider, or some other entity with an interest in selling the agricultural commodity. The registration information may be the same as the registration information described above with respect to FIG. 2A. In one or more embodiments of the invention, the registration is received from a mobile device. The registration information may include categories such as, but is not limited to, a name, contact information, a location, an agricultural commodity, a distance willing to travel, and a size/yield of a farm. A buyer or seller may enter multiple responses for one or more of the categories included in the registration information. Further, multiple buyers and/or sellers may each enter registration information. As part of this step 302, an account number, identification number, or some similar designation may be assigned to the buyer/seller. In addition, the buyer/seller may be asked or required to establish a password or other security measure to limit access to and/or authenticate the use of the account and to the information received by the buyer/seller. Those skilled in the art will appreciate that registration information may be added, deleted, and/or modified by a buyer or seller at any other time in the method described with respect to FIG. 3. In one or more embodiments of the invention, a particular computing device, as described, for example, in FIG. 12 below, is used to receive the registration information from the buyers and sellers.

In step 304, buyer criteria of a primary buyer are received. In one or more embodiments of the invention, the buyer criteria of the primary buyer are received from a mobile device. The buyer criteria may include categories such as, but is not limited to, a purchase quantity of an agricultural commodity, a buyer price of an agricultural commodity, and a deadline by which to transact. The primary buyer may enter multiple responses for one or more of the categories included in the buyer criteria. In one or more embodiments of the invention, the registration information received from the primary buyer, as described above with respect to step 302, is combined with the buyer criteria of the primary buyer. While the buyer criteria for the primary buyer are received, one or more categories of the registration information for the primary buyer may be temporarily or permanently replaced. Those skilled in the art will appreciate that buyer criteria may be added, deleted, and/or modified by the primary buyer at any other time prior to a transaction in the method described with respect to FIG. 3. If a security measure was established in step 302, then the primary buyer may be required to provide the information required to authenticate the account prior to receiving the buyer criteria. In one or more embodiments of the invention, a particular computing device, as described with respect to FIG. 12 below, is used to receive the buyer criteria from the mobile device of the primary buyer.

In step 306, buyer criteria of a secondary buyer are received. In one or more embodiments of the invention, the buyer criteria of the secondary buyer are received from a mobile device. The buyer criteria may include categories such as, but is not limited to a purchase quantity of an agricultural commodity, a buyer price of an agricultural commodity, and a deadline by which to transact. In one or more embodiments of the invention, the registration information received from the secondary buyer, as described above with respect to step 302, is combined with the buyer criteria of the secondary buyer. While the buyer criteria for the secondary buyer are being received, one or more categories of the registration information for the secondary buyer may be temporarily or permanently replaced. Those skilled in the art will appreciate that the categories of the buyer criteria for the secondary buyer may be identical to the categories of the buyer criteria of the primary buyer, as described above with respect to step 304. Those skilled in the art will appreciate that buyer criteria may be added, deleted, and/or modified by the secondary buyer at any other time prior to a transaction in the method described with respect to FIG. 3. If a security measure was established in step 302, then the secondary buyer may be required to provide the information required to authenticate the account prior to receiving the buyer criteria. In addition, those skilled in the art will appreciate that other buyers, each with buyer criteria, may submit such criteria to be received. In one or more embodiments of the invention, a particular computing device, as described with respect to FIG. 12 below, is used to receive the buyer criteria from the mobile device of the secondary buyer.

In step 308, seller criteria of a seller are received. In one or more embodiments of the invention, the seller criteria are received from a seller mobile device. The seller criteria may include categories such as, but is not limited to, a yield from an area of land used to produce the agricultural commodity, a size of the area of land used to produce the commodity, a sales quantity, a location at which to sell the agricultural commodity, and a deadline by which to transact. In one or more embodiments of the invention, the system of the present invention may use the size of the land provided by the seller to compute an estimated amount of produce. The seller criteria may also include a category of a sales price. In one or more embodiments of the invention, the registration information received from the seller, as described above with respect to step 302, may be combined with the seller criteria. While the seller criteria are being received, one or more categories of the registration information for the seller may be temporarily or permanently replaced. Those skilled in the art will appreciate that the categories of the seller criteria for the seller may be identical to the categories of the buyer criteria, as described above with respect to steps 304 and 306. The seller may enter multiple responses for one or more of the categories included in the seller criteria. Those skilled in the art will appreciate that seller criteria may be added, deleted, and/or modified by the seller at any other time prior to a transaction in the method described with respect to FIG. 3. If a security measure was established in step 302, then the seller may be required to provide the information required to authenticate the account prior to receiving the seller criteria. In one or more embodiments of the invention, a particular computing device, as described with respect to FIG. 12 below, is used to receive the seller criteria from the mobile device of the seller.

In step 310, a determination is made as to whether the buyer criteria for the primary buyer or the secondary buyer have changed. If the buyer criteria for the primary buyer or the secondary buyer have changed, then the process reverts to step 304. Those skilled in the art will appreciate that, if the buyer criteria for the primary buyer or the secondary buyer have changed, the process may also revert to a different step in the process, such as step 306. Alternatively, the process proceeds to step 312. In one or more embodiments of the invention, a particular computing device, as described with respect to FIG. 12 below, is used to determine whether the buyer criteria for the primary buyer or the secondary buyer has changed.

In step 312, transaction prices are received from other buyers, other sellers, or other parties involved in transactions for agricultural commodities (e.g., an agent, a broker, etc.). In one or more embodiments of the invention, a transaction price is a price at which a buyer and a seller agree to transact an agricultural commodity. A transaction price may be a seller price, a buyer price, or some other price mutually agreed between the buyer and seller. In one or more embodiments of the invention, transaction prices are received every time a transaction between a buyer and seller using the system of the present invention is executed. Further, transaction prices may be received for many different agricultural commodities. In one or more embodiments of the invention, other information regarding a transaction or potential transaction is received in addition to, or in place of, the transaction prices. For example, a buyer price, a seller price, a transaction date and time, and a location of the transaction for the agricultural commodity may also be received. The transaction prices may also be received from other sources, including (but not limited to) a formal commodity exchange for the agricultural commodity, a market clearinghouse for the agricultural commodity, and any other party not using the method and system of the present invention and with knowledge of market data associated with the agricultural commodity. All transaction prices and related transaction information received may be stored and/or tracked by the system of the present invention. In one or more embodiments of the invention, a particular computing device, as described with respect to FIG. 12 below, is used to receive transaction prices from other buyers and sellers.

In step 314, transaction information is sent to the seller. In one or more embodiments of the invention, the system of the present invention may also send additional information to the seller. The additional information may include high and low transaction prices for the day for the agricultural commodity at the locations corresponding to the primary buyer and secondary buyer. The additional information may further include, but not be limited to, a transaction price and/or quantity for each recent transaction, a date/time of each recent transaction, the buyer and seller prices, and the purchase and sales quantities for the agricultural commodity. The above-mentioned additional information may be sent to the seller periodically, the frequency of which may vary. For example, during a harvest season for an agricultural commodity, the additional information may be sent to a seller of the agricultural commodity several times each day. On a day when the seller intends to sell the agricultural commodity, the additional information may be sent to the seller once new transaction information from other buyers and sellers in the locations that pertain to the seller (e.g., locations within the radius of travel specified by the seller in the seller registration information) are received.

Conversely, at times of the year other than the harvest season, the additional information may be sent less frequently, such as on a weekly basis. Alternatively, the frequency with which the additional information is sent may be defined by the seller, such as part of the seller registration information. In one or more embodiments of the invention, the transaction information is also sent to the primary buyer and/or the secondary buyer. The transaction information may also include forecast information, such as expected buyer and seller prices for an agricultural commodity at a specific location for a certain day or period of time in the future.

In step 316, the seller is matched to the primary buyer. In one or more embodiments of the invention, the seller is matched to the primary buyer based on matching the seller criteria and the buyer criteria of the primary buyer. In one or more embodiments of the invention, the buyer criteria of the primary buyer and the seller criteria may be matched by categorizing one or more components of the buyer criteria and seller criteria based on an exact match or a match within a range of values for the component. Selected components of the buyer criteria and seller criteria, or suitable combinations thereof, may be used in matching the buyer criteria and the seller criteria. For example, a determination may be made that the yield of the seller's farm is sufficient to meet the purchase quantity of the buyer for a particular agriculture commodity, and the transaction location at which to buy the agricultural commodity falls within the plurality of locations the buyer will entertain. In addition to the agricultural commodity for the buyer and the seller being identical, the location of the buyer and the location of the seller, combined with the distance that the seller is willing to travel, may need to overlap to match the buyer criteria and the seller criteria.

Further, the yield of the seller and the purchase quantity of the buyer may each need to fall within a certain quantity category (e.g., a range of purchase quantities) to match the buyer criteria and the seller criteria (i.e., the size of the seller and the size of the buyer need to match). Alternatively, in one or more embodiments, the purchase quantity of the buyer and the yield of the farm of the seller for a specific agricultural commodity, may each need to fall within the same quantity category, where each quantity category (e.g., small, medium, large, very large) represents a range of purchase quantities to match the buyer criteria and the seller criteria based on the yield of the farm of the seller. The size of a market for an agricultural commodity may also be used to match the buyer criteria and the seller criteria. For example, if the seller is considered a small seller (e.g., owns one acre or less of farm land), the seller criteria for that seller may only be matched with buyer criteria of a small number (e.g., three) of buyers, even if the buyer criteria for more than the small number of buyers would otherwise be matched to the seller criteria. The rationale for using the size of the market when matching buyer criteria and seller criteria may be to prevent prices from specific local markets from becoming overbought or oversold (i.e., to more evenly distribute supply and demand among local markets).

In one or more embodiments of the invention, matching the primary buyer and the seller occurs within a predetermined period of time. The predetermined period of time may a default value, defined by the seller, determined by the activity of the applicable market (e.g., number of buyers and sellers, proximity of harvest season, number of recent transactions), defined by some other parameter, or any suitable combination thereof. In one or more embodiments of the invention, a particular computing device, as described with respect to FIG. 12 below, is used to link the seller to the primary buyer based on matching the seller criteria and the buyer criteria of the primary buyer.

In step 318, the seller is matched to the secondary buyer. Those skilled in the art will appreciate that the seller is matched to the secondary buyer based on matching the seller criteria and the buyer criteria of the secondary buyer in a manner similar to that described above with respect to the primary buyer. In one or more embodiments of the invention, a particular computing device, as described with respect to FIG. 12 below, is used to link the seller to the secondary buyer based on matching the seller criteria and the buyer criteria of the secondary buyer.

In step 320, the buyer criteria for the primary buyer and the secondary buyer are sent to the seller. In one or more embodiments of the invention, the buyer criteria of the primary buyer and the secondary buyer are sent to the seller's mobile device. The buyer criteria for the primary buyer and the secondary buyer may be sent as a personalized text or SMS message to the seller. Only relevant portions of the buyer criteria (e.g., buyer price, location, and purchase quantity) may be sent to the seller. The buyer criteria that are sent to the seller may be limited to a certain number of buyers (e.g., primary buyer, secondary buyer). For example, the size/yield of the farm owned by a seller or the sales quantity of the agricultural commodity that a seller is offering for sale may be used to determine the number of buyers whose buyer criteria is sent to the seller. In one or more embodiments of the invention, a particular computing device, as described with respect to FIG. 12 below, is used to send the buyer criteria of the primary buyer and the secondary buyer to the seller on the seller mobile device.

Optionally, in step 322, revised buyer criteria of the primary buyer and seller are received. In one or more embodiments of the invention, the revised buyer criteria and the revised seller criteria may be received after the primary buyer and the seller execute a transaction for the agricultural commodity. The revised buyer criteria of the primary buyer may include a change to one or more categories relative to the buyer criteria submitted in step 304. Those skilled in the art will appreciate that revised buyer criteria of the secondary buyer may also be received. For example, the secondary buyer may send revised buyer criteria after executing a transaction for the agricultural commodity with a different seller. The revised buyer criteria and/or the revised seller criteria may include the terms of an executed transaction between the buyer and the seller. In one or more embodiments of the invention, the buyer and/or seller may be required, as a condition of continued use of the services provided by the method and/or system, to report the details of each transaction executed using the method and/or system. In one or more embodiments of the invention, a particular computing device, as described with respect to FIG. 12 below, is used to receive the revised buyer criteria from the mobile device of the primary buyer.

Turning to FIG. 4, FIG. 4 shows a flowchart of the method for matching parties to a transaction for an agricultural commodity from the perspective of a seller of the agricultural commodity. The method described in this FIG. 4 may be performed at varying frequencies, depending on factors that include, but are not limited to, the sales quantity, the area of land used to produce the agricultural commodity, the perishability of the agricultural commodity, the time of year (e.g., harvest season for the agricultural commodity), and the location of the seller. For example, during harvest season, a seller may perform the method described in FIG. 4 once per day or once per week, whereas during planting season, the seller may not perform the method described in FIG. 4 at all. In step 402, registration information is sent by a buyer or a seller. Those skilled in the art will appreciate that the registration information and embodiments associated with the registration information are similar to that described above with respect to step 302 of FIG. 3. In one or more embodiments of the invention, a particular computing device, as described with respect to FIG. 12 below, is used to send the registration information.

In step 404, criteria are sent. The criteria may be that of a buyer and/or a seller. In one or more embodiments of the invention, the criteria are sent from a mobile device. The criteria may include categories such as, but is not limited to, a purchase/sales quantity, buyer/seller price, and a deadline by which to transact for one or more agricultural commodities. In one or more embodiments of the invention, the registration information received from the entity (e.g., buyer, seller), as described above with respect to step 402, is combined with the criteria of that entity. Those skilled in the art will appreciate that the criteria and embodiments associated with the criteria are similar to that described above with respect to step 304 of FIG. 3. In one or more embodiments of the invention, a particular computing device, as described with respect to FIG. 12 below, is used to send the criteria.

In step 406, the buyer criteria for the primary buyer and the secondary buyer are received by a seller on a seller mobile device. The buyer criteria of the primary buyer and the secondary buyer may be sent as a personalized text or SMS message to the seller. Accordingly, the seller is now matched with at least two buyers by the system of the present invention. In receiving the buyer criteria, the seller may also receive current pricing for his agricultural commodity based on location. In one or more embodiments of the invention, each component of the buyer criteria for each buyer falls within a predefined range of a corresponding component of the seller criteria. For example, if the seller specifies that the seller is willing to travel up to 10 kilometers to deliver his agricultural commodity, then the buyers associated with the buyer criteria received will all be located within 10 kilometers of the seller. In one or more embodiments of the invention, a particular computing device, as described with respect to FIG. 12 below, is used to receive the buyer criteria for the primary buyer and the secondary buyer.

In step 408, the buyer criteria for the primary buyer and the secondary buyer are evaluated. Typically, where the seller would not have any information regarding the particularities of buyers' locations, quantity desired, etc., the seller in step 406, has the majority of information necessary to make an informed decision about which buyer to contact first, and which location to visit to sell the agricultural commodity. A seller evaluating the buyer criteria for the primary buyer and the secondary buyer may consider one or more categories of the buyer criteria. The evaluation by the seller may also include factors outside the categories of the buyer criteria and seller criteria. For example, a cost to transport (e.g., fuel cost, truck rental) the agricultural commodity to a buyer location may be considered by the buyer in evaluating the buyer criteria for the primary buyer and the secondary buyer. In one or more embodiments of the invention, a particular computing device, as described with respect to FIG. 12 below, is used to evaluate the buyer criteria for the primary buyer and the secondary buyer. In step 410, the primary buyer is selected based on the buyer criteria. In one or more embodiments of the invention, a particular computing device, as described with respect to FIG. 12 below, is used to select the primary buyer based on the buyer criteria.

In step 412, the primary buyer is contacted to execute a transaction for the agricultural commodity. A transaction for the agricultural commodity may or may not be executed between the primary buyer and the seller. In one or more embodiments of the invention, the negotiation between the primary buyer and the seller is based on the buyer criteria of the primary buyer. A transaction for the agricultural commodity may or may not be executed between the primary buyer and the seller, depending on the negotiations between the entities. The primary buyer may be contacted by the seller using a mobile device. The primary buyer may be contacted using the contact information provided to the seller in the personalized message on the seller's mobile device. If a transaction is executed between the primary buyer and the seller, then the process ends. Optionally, if a transaction is executed between the primary buyer and the seller, then the process may proceed to step 416. In one or more embodiments of the invention, a particular computing device, as described with respect to FIG. 12 below, is used to contact the primary buyer to execute the transaction for the agricultural commodity.

Optionally, in step 414, the secondary buyer is contacted to execute a transaction for the agricultural commodity. The secondary buyer may be contacted if the seller, after step 412, continues to have the agricultural commodity to sell. For example, the primary buyer may not have been available when the seller attempted to contact the primary buyer using the contact information provided by the primary buyer. Alternatively, the seller may have contacted the primary buyer, but the negotiations between the primary buyer and the seller failed to result in a transaction for the agricultural commodity. In one or more embodiments of the invention, the negotiation between the secondary buyer and the seller is based on the buyer criteria of the secondary buyer. The secondary buyer may be contacted using the contact information provided by the secondary buyer in the registration information. After the secondary buyer is contacted to execute a transaction of the agricultural commodity, the process may end or, optionally, the process may proceed to step 416. In one or more embodiments of the invention, a particular computing device, as described with respect to FIG. 12 below, is used to contact the secondary buyer to execute the transaction for the agricultural commodity.

In addition, optionally, in step 416, revised seller criteria are sent by the mobile device of the seller. In one or more embodiments of the invention, the revised seller criteria are received after the seller executes a transaction for the agricultural commodity. The revised seller criteria may have a change to one or more categories relative to the seller criteria sent in step 404. Those skilled in the art will appreciate that revised buyer criteria of the secondary buyer may also be sent using the mobile device of the secondary buyer. For example, the secondary buyer may send revised buyer criteria after executing a transaction for the agricultural commodity with the seller. The revised seller criteria may include the terms of an executed transaction between the secondary buyer and the seller. In one or more embodiments of the invention, the seller may be required, as a condition of continued use of the services provided by the method and/or system, to report the details of each transaction executed using the method and/or system. In one or more embodiments of the invention, a particular computing device, as described with respect to FIG. 12 below, is used to receive the revised buyer criteria from the mobile device of the primary buyer.

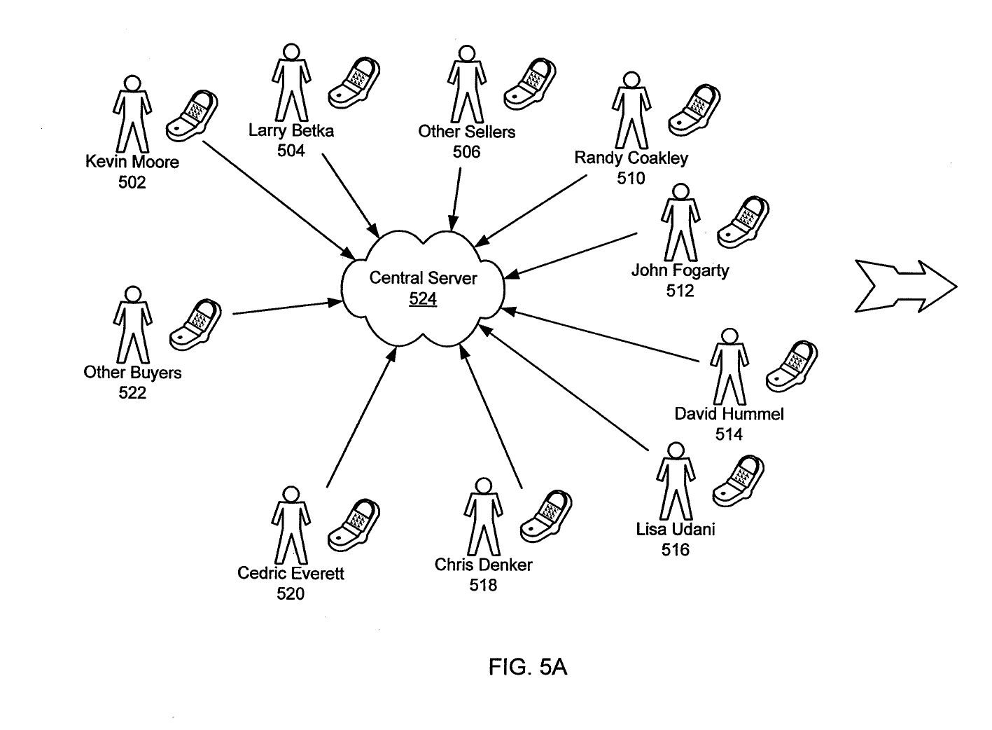

FIGS. 5A-13 show examples for matching parties to a transaction for an agricultural commodity in accordance with one or more embodiments of the invention. The examples described below are not meant to limit the invention in anyway.

### Example A

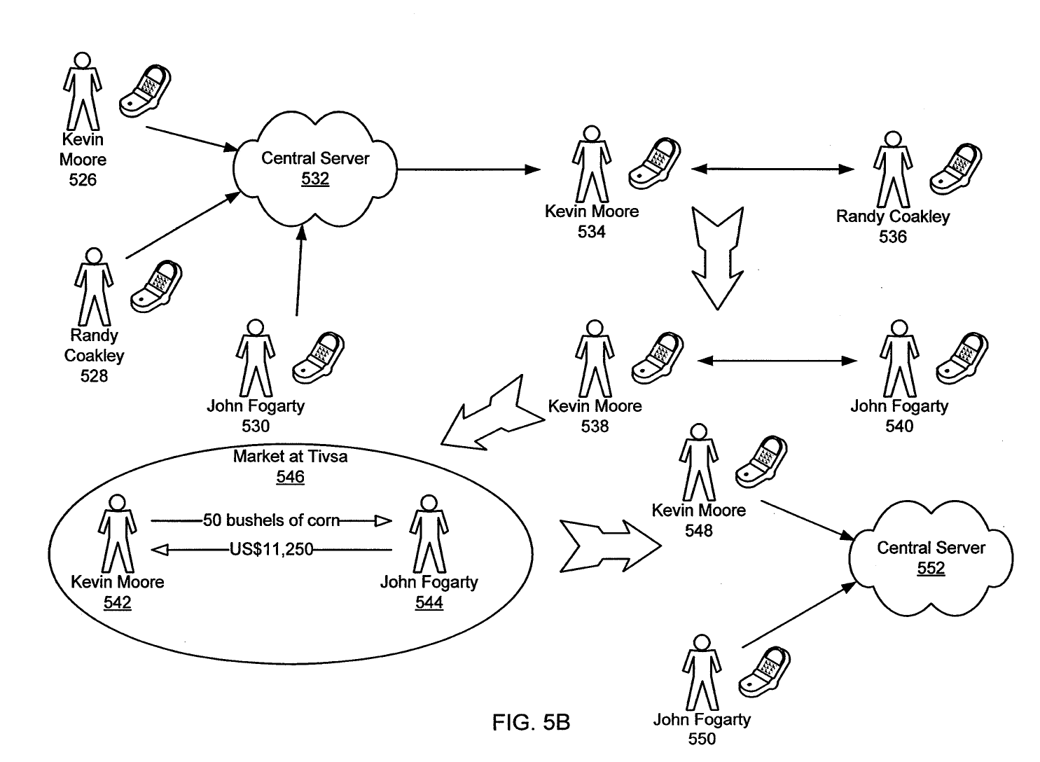

Consider an example in FIGS. 5A-9B where parties to a transaction for an agricultural commodity use cell phones to become matched for the transaction. In this example, all parties are located in a rural part of India, as explained below. FIG. 5A shows a number of people, each with a cell phone, sending information to a central server (524). Specifically, Kevin Moore (502) and Larry Betka (504) represent two sellers of corn. Other Sellers (306) represent other sellers of corn. As for buyers, Randy Coakley (510), John Fogarty (512), David Hummel (514), Lisa Udani (516), Chris Denker (518), and Cedric Everett (520) represent buyers of corn. Other Buyers (522) represent other buyers of corn. Each of the sellers (i.e., Kevin Moore (502), Larry Betka (504), and Other Sellers (506)) and each of the buyers (i.e., Randy Coakley (510), John Fogarty (512), David Hummel (514), Lisa Udani (516), Chris Denker (518), Cedric Everett (520), and Other Buyers (522)) send registration information to the central server (524). In this example, each buyer and seller sends the registration information to the central server (524) in SMS format using a cell phone. An example of the registration information for Kevin Moore (502) is described below with respect to FIG. 6A.

In FIG. 6A, the registration information for Kevin Moore (600) is shown. The registration information for Kevin Moore (600) contains eight different fields or categories. The eight categories for a seller are a name, a phone number, a street address of the farm, a city of the farm, a state of the farm, the crop grown, the number of acres of the farm, and the distance the seller is willing to travel to complete a transaction. Variations of the seller registration information may exist. For example, an email address may be provided instead of, or in addition to, the phone number. In addition, if the seller is an aggregator rather than a farmer, or if the seller has stored the agricultural commodity at a different location from where the agricultural commodity was produced, then the location information is likewise reflected in the registration information. The categories for the registration information of each buyer are similar to those shown in FIG. 6A with some differences accounting for the differing characteristics of the buyer. For example, the location of one or more markets from which the buyer wants to transact or is located would replace the categories related to the location of the farm for the seller, as shown in FIG. 6A.

Referring to FIG. 5B, after the buyers and sellers have registered as described above with respect to FIG. 5A, the buyers and sellers are prepared to transact for the agricultural commodity. In this example, buyers Randy Coakley (528) and John Fogarty (530) are prepared to buy corn, and seller Kevin Moore (526) is prepared to sell corn. Kevin Moore (526), Randy Coakley (528), and John Fogarty (530) each enter their respective criteria for a transaction of the agricultural commodity to the central server (532). In this example, Kevin Moore (526), Randy Coakley (528), and John Fogarty (530) each send their respective criteria to the central server (532) in SMS format using a cell phone. An example of the criteria for Randy Coakley (528) is described below with respect to FIG. 6B.

In FIG. 6B, the criteria for Randy Coakley (650) is shown. The criteria for Randy Coakley (650) contain five different fields or categories. The five categories are a name, a quantity (i.e., a purchase quantity), a unit of measure for the agricultural commodity, a transaction deadline, and a price per unit (i.e., a buyer price). Variations of the criteria for a buyer may exist. For example, a choice of currency may be a component presented if, for example, U.S. dollars and Mexican pesos are commonly exchanged at the buyer's location. In addition, if the buyer wants to place an order for the future, an extra component allowing for entry of a transaction start date may be added. Further, if the buyer wants to buy a purchase quantity at the best price available, regardless of the price, the price per unit component may be configured to accept an entry from the buyer for “best available.” The categories for the registration information of each seller are similar to those shown in FIG. 6B with some differences accounting for the differing characteristics of the seller. For example, the seller may not be presented with, or may choose to ignore, a price per unit component. In addition, buyers and sellers may temporarily or permanently change a component in the registration information while sending the criteria. For example, a seller may decide, for purposes of the present transaction, to change his distance willing to travel from 50 km to 25 km because of rising fuel costs or because of a vehicle being out of service.

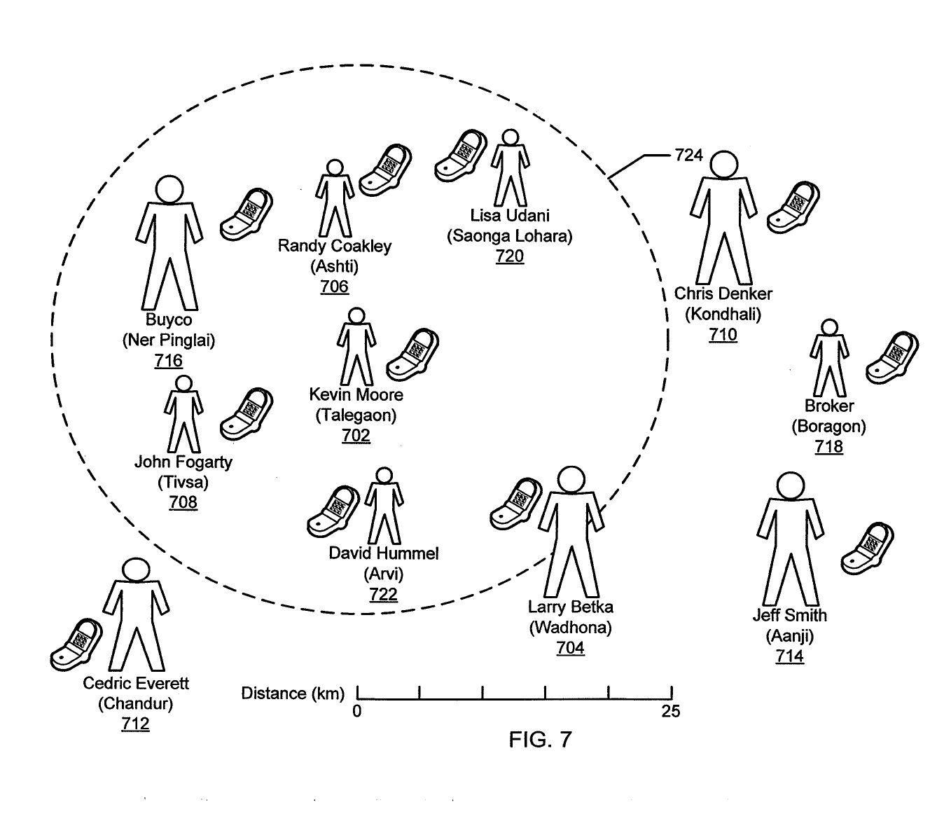

FIG. 8A shows an example of an exchange of criteria from Kevin Moore, as a seller, to Agrinova (i.e., the central server). Specifically, FIG. 8A shows a cell phone display (815) of the Kevin Moore cell phone (810), where messages are sent back and forth using SMS format. In the cell phone display (815), Kevin tells Agrinova that he has 50 bushels of corn to sell today. Agrinova confirms receipt of the offer and confirms the location of the farm where the corn is produced. Agrinova also asks if any of the registration information needs to change for this transaction. Kevin responds that he is only willing to travel 25 km for this transaction. Agrinova ends the exchange by telling Kevin that Kevin will be receiving a series of text messages within the next four hours with bids from potential buyers.

FIG. 8B shows an example of an exchange of criteria from Randy Coakley, as a buyer, to Agrinova (i.e., the central server). Specifically, FIG. 8B shows a cell phone display (825) of the Randy Coakley cell phone (820), where messages are sent back and forth using SMS format. In the cell phone display (825), Randy tells Agrinova that he wants to buy 50 bushels of corn today before 4:00 CST. Agrinova confirms receipt of the bid, confirms the location where Randy wants to buy, and confirms the phone number at which a seller can reach Randy. Agrinova also asks if any of the registration information needs to change for this transaction. Randy responds that his registration information remains unchanged, and Agrinova ends the exchange by telling Randy that potential sellers will be notified of the bid and that a potential seller will contact Randy directly to execute a transaction. Although FIGS. 8A and 8B show a more interactive exchange between an entity and a central server, it is also possible that the messages exchanged contain only facts and are not interactive.

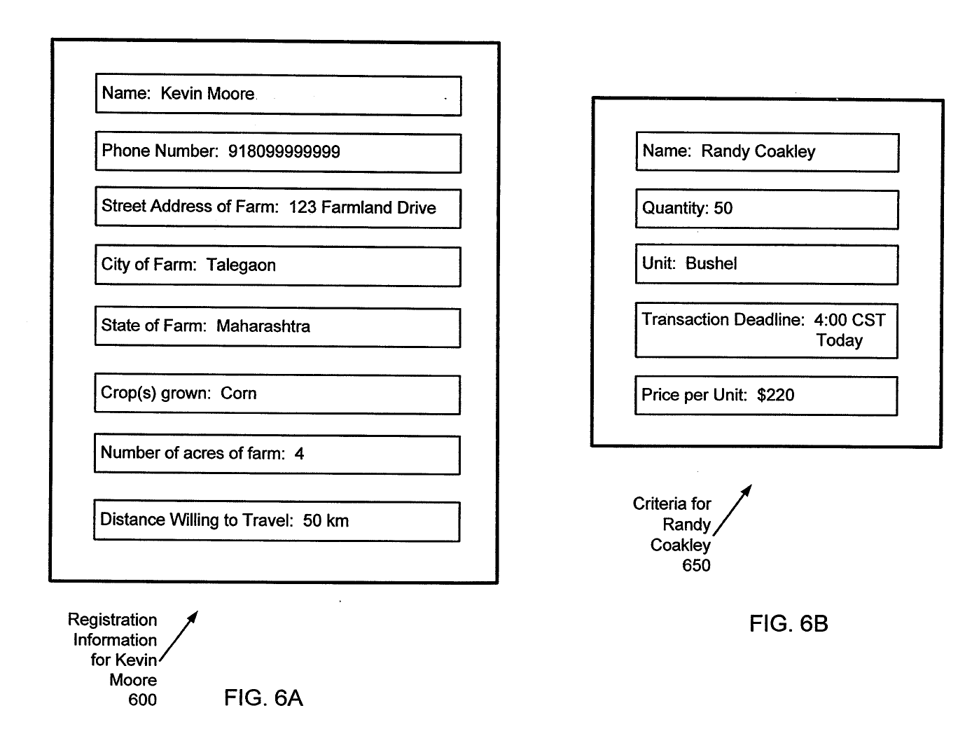

In processing the criteria received from the buyers and sellers to match parties to a transaction of the agricultural commodity, a number of categories from the buyer registration information and criteria are matched with corresponding categories from the seller registration information and criteria. An obvious component that must be matched is the agricultural commodity such that the agricultural commodity being offered for sale by the seller is the same agricultural commodity being sought by the buyer. FIG. 7 shows an example of two other criteria, geographic location and relative size of the parties, which may be used to create a match of buyers and sellers.

FIG. 7 shows buyers as Kevin Moore (702) and Larry Betka (704). FIG. 7 also shows sellers as Randy Coakley (706), John Fogarty (708), Chris Denker (710), Cedric Everett (712), Jeff Smith (714), Buyco (716), Broker (718), Lisa Udani (720), and David Hummel (722). In this example, Buyco (716) and Broker (718) represent an aggregator of buyers and a broker for buyers, respectively. Geographically, all parties are located in the state of Maharashtra in India. Specifically, the farm of Kevin Moore (702) is located in Talegaon, and the farm of Larry Betka (704) is located in Wadhona. As for the buyers, Randy Coakley (706) is located in Ashti, John Fogarty (708) is located in Tivsa, Chris Denker (710) is located in Kondhali, Cedric Everett (712) is located in Chandur, Jeff Smith (714) is located in Aanji, Buyco (716) is located in Ner Pinglai, Broker (718) is located in Boragon, Lisa Udani (720) is located in Saonga Lohara, and David Hummel (722) is located in Arvi. Based on the criteria sent by Kevin Moore, as described above with respect to FIG. 8A, Kevin Moore is only willing to travel 25 km to sell his corn. A 25 km radius (724) from the farm that produces the corn is shown. Therefore, the bid of all buyers located outside the 25 km radius (724) (i.e., Chris Denker (710), Cedric Everett (712), Jeff Smith (714), and Broker (718)) will not be sent to Kevin Moore.

Continuing with FIG. 7, another component that may be matched is relative size of each buyer and seller. The size of a buyer/seller is dependent on the quanity of the agricultural commodity that the seller is selling (or the yield that the seller's farm can produce) and the buyer is interested in buying. For example, any purchase quantity in a range between 40 bushels and 70 bushels submitted by a buyer or a seller will be considered a match for that quantity category. Alternatively, rather than consider the sales quantity offered by the seller, the size (and effectively the yield) of the seller's farm, in terms of a quantity category (discussed above with respect to step 316 of FIG. 3), may be used to match with the purchase quantity of the buyer. For example, a seller may be categorized as a small seller if the seller's tract of land is one acre or less. Alternatively, a seller selling between 40 and 70 bushels of a commodity may be categorized as a small seller. For example, if the size of a farm is four acres, and the expected yield for an acre of corn in that geographic location is 120 bushels per acre, then the seller may be matched with buyers based on the four acre tract of land the seller owns rather than the number of bushels the seller actually has to sell.

The relative size of buyers and sellers is shown in FIG. 7. The figures drawn on a smaller scale (i.e., shown as physically smaller figures) (i.e., Kevin Moore (702), Randy Coakley (706), John Fogarty (708), Broker (718), Lisa Udani (720), and David Hummel (722)) represent smaller quantities relative to the larger figures (i.e., Larry Betka (704), Chris Denker (710), Cedric Everett (712), Jeff Smith (714), and Buyco (716)).

As a result of matching for relative market size, in the example shown in FIG. 7, Buyco (716) is not presented to Kevin Moore (702) as a potential buyer, even though Buyco (716) is within the 25 km radius (724) of the farm of Kevin Moore (702), because the purchase quantity sought by Buyco (716) is too large for what Kevin Moore (702) is capable of supplying. Also, even though Broker (718) is considered to be the same relative size as Kevin Moore (702), Broker (718) is not presented to Kevin Moore (702) as a potential buyer because Broker (718) is located more than 25 km from the farm of Kevin Moore (702).

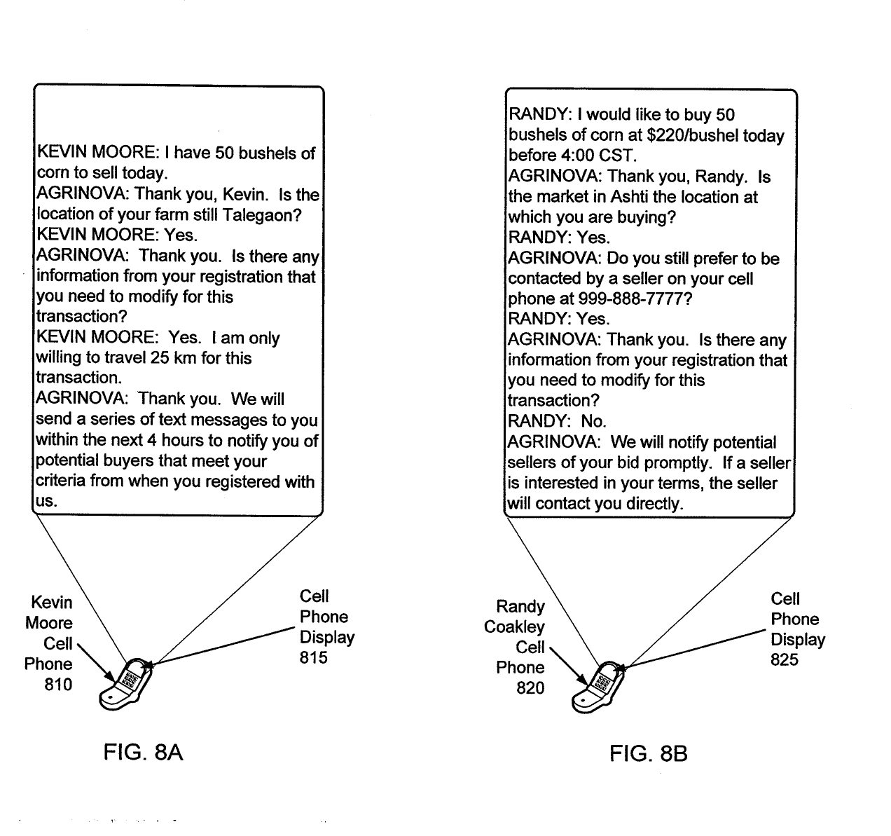

Returning to FIG. 5B and continuing with the example, once the central server (532) has received criteria from Kevin Moore (526), and all of the buyers, including Randy Coakley (528), and John Fogarty (530), the central server (530) sends several text messages to Kevin Moore's cell phone (534) in SMS format. The text messages sent by the central server (532) contain bid information from one or more buyers. In this example, as shown in FIG. 9A, the Kevin Moore cell phone (910), as shown on the cell phone display (915), receives bids from four different buyers. After receiving the bids, Kevin Moore evaluates each of the bids to determine which he should pursue. In addition to the pricing and purchase quantity, the seller may also consider other factors, such as the cost associated with delivering the agricultural commodity to the buyer's respective location. The bids (i.e., buyer prices) received from the buyers may be indicative, as shown in FIG. 9A, or they may be firm (i.e., binding) bids.

If a buyer changes any criteria that affect a potential transaction with the seller, then the changes are immediately sent to the seller once received. In FIG. 9B, the Kevin Moore cell phone (920), as shown on the cell phone display (925), receives two revised bids based on buyer criteria that has been modified. First, Lisa Udani withdrew her bid completely. Second, David Hummel reduced his desired purchase quantity from 50 to 40 and increased his bid price (i.e., buyer price) from $205/bushel to $210/bushel.

Once the seller determines the best buyer price based on the criteria received from each of the buyers on the cell phone, the seller contacts the buyer with the best buyer price using the contact information provided by that buyer. The contact information of the buyer may be listed expressly, it may be shown as a link (as shown in FIG. 9A, where the name of the bidder embedded in the text message may be selected to call that bidder), or a combination thereof. In the example shown in FIG. 5B, Kevin Moore (534) decides that the bid from Randy Coakley (536) is the best of the four options that are presented. Once the buyer is contacted, the buyer and seller discuss terms in an attempt to execute a transaction for the agricultural commodity.

If the buyer and seller are able to agree to terms, the buyer and seller enter into and execute a contract according to those negotiated terms. The negotiated terms of the agreement between the buyer and seller may be the same as the buyer criteria, or the terms may include some other criteria that are mutually agreed between the buyer and seller. If the buyer and seller are unable to reach an agreement, however, then the seller may select a different buyer from the list of buyers received. In the example shown in FIG. 5B, Kevin Moore (538) contacts John Fogarty (540) because negotiations between Kevin Moore (534) and Randy Coakley (536) failed to yield an agreement to which both parties agree.

Continuing with FIG. 5B, after Kevin Moore (538) and John Fogarty (540) agree on negotiated terms to transact the corn, then the transaction occurs according to those negotiated terms. In this example, Kevin Moore (542) gives his 50 bushels of corn to John Fogarty (544) at the market at Tivsa (546) in exchange for $11,250 (i.e., 50 bushels at $225/bushel). After the transaction has been executed (or, at the discretion of the buyer and/or seller, at some earlier point in time), the seller and/or buyer modify their criteria based on the transaction for the agricultural commodity. In FIG. 5B, Kevin Moore (548) and John Fogarty (550) each send revised criteria to the central server (552) using a cell phone. The modified criteria may be a change to a single component, withdrawal of all categories in the criteria, or some other modification. Further, the seller may be required, as part of the registration process, to send the details of the transaction after the contract has been executed. In FIG. 5B, Kevin Moore (548) may send the transaction price, transaction quantity, and transaction location for the agricultural commodity to the central server (552).

### Example B

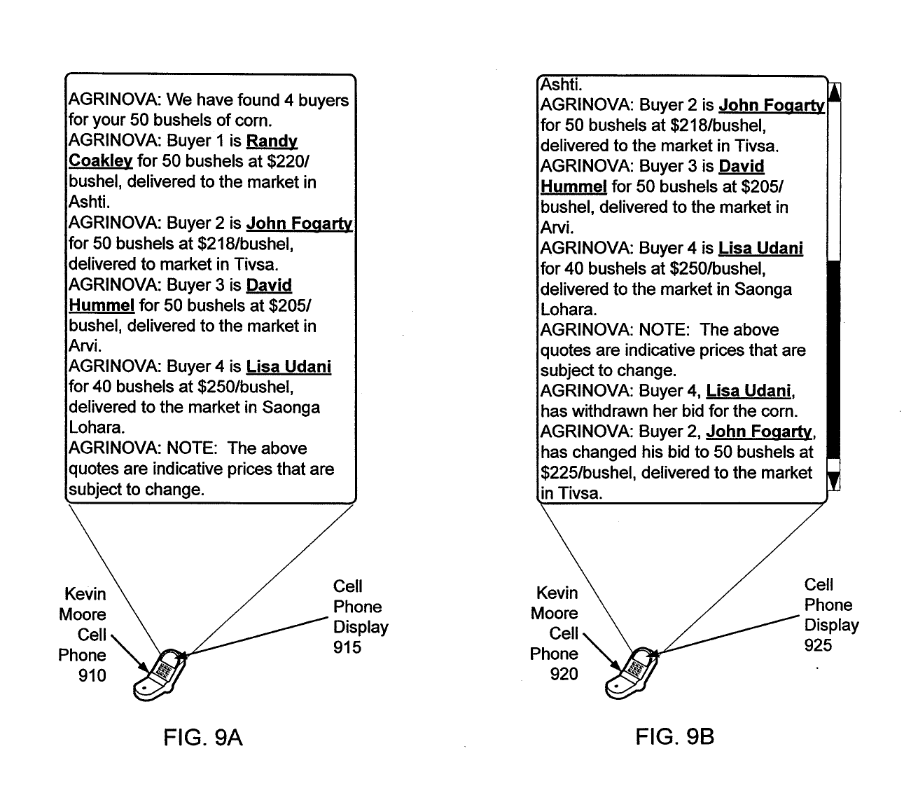

Consider an example in FIG. 10 where a different embodiment of matching parties to a transaction for an agricultural commodity is discussed. Specifically, FIG. 10 shows an example of weather information sent to a farmer that may be used to help the farmer make an informed decision as to which crop to plant in a future growing season. In FIG. 10, a farmer cell phone (1010), as shown on the cell phone display (1015), shows weather information disclosing that rainfall levels for the coming growing season are expected to be below normal in the location of the farmer's farm. Because of the forecast shortage of rainfall, as well as projected pricing of different agricultural commodities, a recommendation is made to grow corn in the coming year instead of sugar cane. The farmer is also given a link to contact in the event that the farmer needs more information or has questions.

In one or more embodiments of the invention, the weather data is for a particular location, such as a location of a farm that produces an agricultural commodity grown by the seller. The weather data may come in a variety of formats and from a variety of sources. The weather data may be historical, a forecast, or any suitable combination thereof. The weather data may be actual weather data or data that is related to weather.

In one or more embodiments of the invention, the weather information is generated using the weather data. The weather information may be the output of a model that uses algorithms and programs to process the weather data. The weather information may be manipulated in a number of ways. Input from a buyer and/or seller may be received to determine the format and content of the weather information.

In one or more embodiments of the invention, the weather information is sent. The weather information may be sent to an entity with an interest in an agricultural commodity, including but not limited to a seller of the agricultural commodity, a farmer growing the agricultural commodity, an aggregator of the agricultural commodity, or a broker of the agricultural commodity. In one or more embodiments of the invention, the weather information is sent in a format readable by the recipient. Examples of a format of the weather information include, but are not limited to, a text message in SMS format, a hard copy mailed to the recipient, a spreadsheet, and a link to a website. The weather information may be specific for geographic location, such as a farm producing the agricultural commodity. The weather information may be personalized for the recipient to whom the weather information is sent.

### Example C

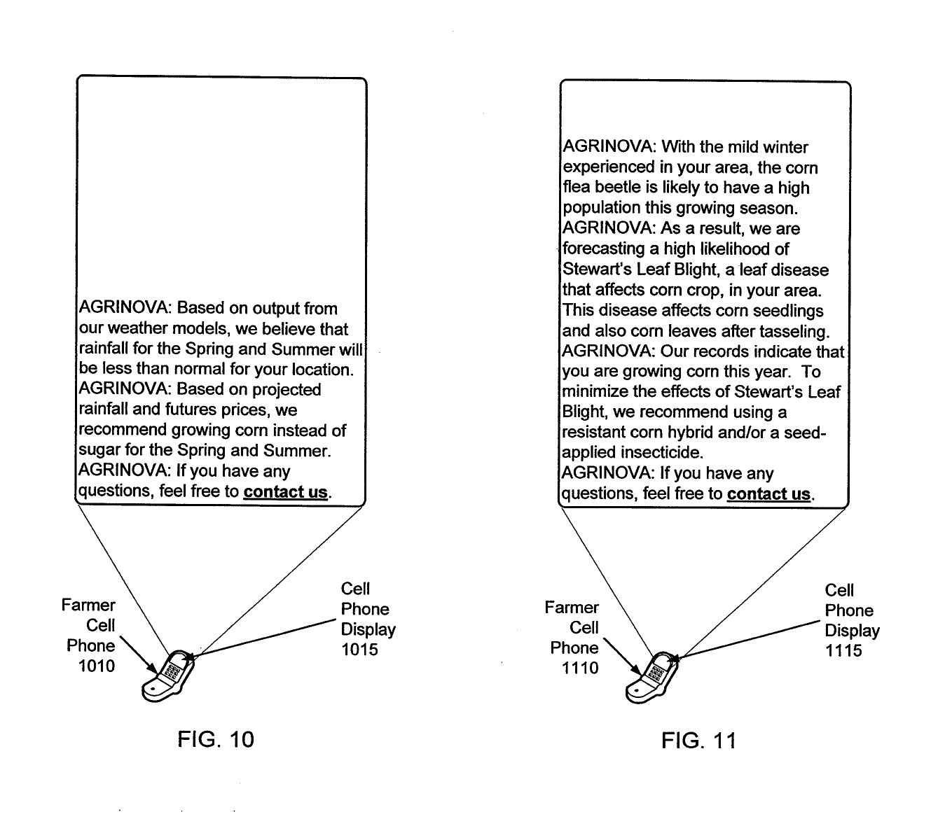

Consider an example in FIG. 11 where another embodiment of matching parties to a transaction for an agricultural commodity is discussed. Specifically, FIG. 11 shows an example of viability information sent to a farmer that may be used to help the farmer make an informed decision as to which crop to plant in a future growing season. The farmer cell phone (1110), as shown on the cell phone display (1115), may show viability information disclosing that the corn flea beetle population is likely to be high for the coming growing season for farmer's location within the state. As a result, as disclosed by the viability information, Stewart's Leaf Blight will need to be controlled using a resistant corn hybrid and/or a seed-applied insecticide. The farmer is also given a link to contact in the event that the farmer needs more information or has questions.

In one or more embodiments of the invention, viability data affecting an agricultural commodity is received. The viability data may be any data related to any aspect of the health of an agricultural commodity, including but not limited to diseases, fungus, fertilizer technology, farming equipment, farming techniques, soil maintenance, the type of soil in the region, the supply, demand, and historical/forecast pricing of commodities related to the agricultural commodity (e.g., seeds used to produce the agricultural commodity), and drainage. The viability data may come in a variety of formats and from a variety of sources. The viability data may be historical, a forecast, geographically-directed, or any suitable combination thereof. In one or more embodiments of the invention, a particular computer, as described with respect to FIG. 12 below, is used to receive the viability data affecting the agricultural commodity.

In one or more embodiments of the invention, viability information is generated using the viability data. The viability information may be the output of a model that uses algorithms and programs to process the viability data. The viability information may be manipulated in a number of ways. Input from a buyer and/or seller may be received to determine the format and content of the viability information. In one or more embodiments of the invention, a particular computer, as described with respect to FIG. 12 below, is used to generate the viability information using the viability data.

In one or more embodiments of the invention, viability information is sent. In one or more embodiments of the invention, the viability information is sent to an entity with an interest in the agricultural commodity, including but not limited to a seller of the agricultural commodity, a farmer growing the agricultural commodity, an aggregator of the agricultural commodity, or a broker of the agricultural commodity. In one or more embodiments of the invention, the viability information is sent in a geographical-directed manner based on the location of the recipient. In one or more embodiments of the invention, the viability information is sent in a format readable by the recipient. Examples of a format of the weather information include, but are not limited to, a text message in SMS format, a hard copy mailed to the recipient, a spreadsheet, and a link to a website. The viability information may be personalized for the recipient to whom the viability information is sent. In one or more embodiments of the invention, a particular computer, as described with respect to FIG. 12 below, is used to send the viability information.

Other embodiments that are ancillary to matching parties to a transaction for an agricultural commodity in accordance with one or more embodiments of the invention may also exist. For example, similar information associated with historical and future pricing for an agricultural commodity may be generated and sent. Capturing transaction prices from sellers using the system to match parties to a transaction for an agricultural commodity will provide more transparency to local farmers selling agricultural commodities in local markets.

As another example, the method and system described above may be modified to provide additional functionality, including but not limited to facilitating negotiations between a buyer and seller, providing a mechanism for securing transactions (i.e., solving for credit-related issues), creating standard contract templates for agricultural commodities, issuing contracts to a buyer and seller of a transaction, and resolving disputes between contracting parties. Further, the method and system described above may be modified to provide functionality related to transportation of the agricultural commodity, including but not limited to current and future fuel costs, vehicle costs, emerging transportation technologies, and transportation services. In one or more embodiment of the invention, the functionality related to calculation of a cost for transporting goods by the seller of the agricultural commodity may be applied for markets beyond a certain distance (e.g., 100 kilometers) from the location of the seller. Further, transportation of goods may be provided by a third party, such as a logistics provider, that helps both parties to the agricultural transaction by transporting produce to a distant location.

In addition, the method and system described above may be modified to include global positioning system (GPS) capabilities. For example, if a seller is traveling with the agricultural commodity and does not change the seller criteria corresponding to the locations and/or markets to which the seller is willing to sell the agricultural commodity, the traveling location of the seller may be determined using GPS, and the seller may receive a message (in SMS format, for example) suggesting potential markets relative to the seller's then-current location. Those skilled in the art will appreciate that the GPS capabilities described above may also apply to a buyer who may be traveling and desires to transact with potential farmers in the area currently being visited by the buyer.

Further, the method and system described above may be modified to include third parties that may be involved in the transaction. For example, a logistics provider (e.g., a transportation services company) may be able to offer pricing for its services to a buyer and/or seller to deliver an agricultural commodity from one location to another location. Likewise, a buyer and/or seller may communicate with the logistics provider to reach an agreement regarding the transportation of an agricultural commodity. Other third parties, including (but not limited to) crop dusters, planting services, and harvesting services, may also be included in the method and system described above.

Embodiments of the present invention may be utilized by small farmers in rural areas where internet access is not widely available or used. In addition, embodiments of the present invention may be utilized by buyers in local markets where internet access is not widely available or used. For example, many parts of India are rural having a large number of farmers with relatively small plots of land to farm (e.g., four acres) where very few of the farmers have internet access. However, most of the rural farmers in India have cell phones that are configured to receive text messages in SMS or similar format. In addition, a number of local markets exist throughout rural India where Mandi agents represent buyers. There is little price discovery for an agricultural commodity for many of these local markets in India.

Further, embodiments of the invention provide real-time, regularly updated pricing for local, relatively small markets of an agricultural commodity. This market transparency promotes more efficient markets and gives a seller of the agricultural commodity a true market value, rather than merely taking the best buyer price the seller can get at the local market to which the seller brings the agricultural commodity. This market transparency is especially crucial when the agricultural commodity is perishable. In addition to creating a more efficient market and giving a seller increased profit for the agricultural commodity, the present invention also helps the farmer manage cash flow and maximize the use of his farm by anticipating market trends for various agricultural commodities. The present invention also benefits buyers by giving buyers access to more sellers in the marketplace, where the sellers deal in quantities that are consistent with the interests of the buyer.

Embodiments of the invention may be implemented on virtually any type of computing device regardless of the platform being used. For example, as shown in FIG. 12, a computer system (1200) includes one or more processor(s) (1202) (e.g., hardware such as an integrated circuit or other processing circuitry), associated memory (1204) (e.g., RAM, cache memory, flash memory, etc.), a storage device (1206) (e.g., a hard disk, an optical drive such as a compact disk drive or digital video disk (DVD) drive, a flash memory stick, etc.), and numerous other elements and functionalities typical of today's computers (not shown). The computer system (1200) may also include input means, such as a keyboard (1208), a mouse (1210), or a microphone (not shown). Further, the computer system (1200) may include output means, such as a monitor (1212) (e.g., a liquid crystal display (LCD), a plasma display, or cathode ray tube (CRT) monitor). The computer system (1200) may be connected to a network (1214) (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms, now known or later developed. Generally speaking, the computer system (1200) includes at least the minimal processing, input, and/or output means necessary to particularly practice embodiments of the invention.

Further, those skilled in the art will appreciate that one or more elements of the aforementioned computer system (1200) may be located at a remote location and connected to the other elements over a network. Further, embodiments of the invention may be implemented on a distributed system having a plurality of nodes, where each portion of the invention (e.g., central server, buyer mobile device, seller mobile device) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a tangible computer readable medium such as a compact disc (CD), a diskette, a tape, or any other suitable tangible computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for matching parties to a transaction of an agricultural commodity, the method comprising:
receiving a plurality of buyer criteria, wherein each of the plurality of buyer criteria is sent from a mobile device used by one of a plurality of buyers of the agricultural commodity,
wherein the plurality of buyers comprises a primary buyer and a secondary buyer, and
wherein each of the plurality of buyer criteria comprises a purchase quantity, a buyer price, and a transaction location at which to buy the agricultural commodity;
receiving seller criteria for the agricultural commodity sent from a seller mobile device, wherein the seller criteria comprises a sales quantity, a yield from an area of land used to produce the agricultural commodity, and a plurality of locations at which to sell the agricultural commodity;
matching, within a predetermined period of time after receiving the plurality of buyer criteria and the seller criteria, each of the plurality of buyers with the seller based on determining that the yield is sufficient to meet the purchase quantity and the transaction location at which to buy the agricultural commodity falls within the plurality of locations; and
sending the plurality of buyer criteria to the seller mobile device using short message service (SMS) format.

2. The method of claim 1, wherein the seller, using the seller mobile device, selects a buyer criteria of the primary buyer from the plurality of buyer criteria and contacts the primary buyer using contact information provided by the primary buyer to execute the transaction of the agricultural commodity at a transaction price based on the buyer criteria of the primary buyer.

3. The method of claim 2, wherein the seller is unable to execute the transaction with the primary buyer and, using the seller mobile device, contacts the secondary buyer using contact information provided by the secondary buyer to execute the transaction of the agricultural commodity at a transaction price based on a buyer criteria of the secondary buyer upon selecting the buyer criteria of the secondary buyer from the plurality of buyer criteria.

4. The method of claim 2, further comprising:
storing the transaction price; and
generating a history of transaction prices for the agricultural commodity, the history of transaction prices comprising the transaction price and a plurality of previously executed transaction prices.

5. The method of claim 4, wherein the history of transaction prices for the agricultural commodity is based on the transaction location.

6. The method of claim 4, further comprising:
generating a forecast transaction price at the transaction location using the history of transaction prices; and
sending the forecast transaction price at the transaction location to the seller mobile device.

7. The method of claim 1, wherein the agricultural commodity is a crop produced by the seller.

8. The method of claim 1, wherein each of the plurality of buyer criteria and the seller criteria include a predetermined range of time in which to execute the transaction.

9. The method of claim 1, wherein the seller criteria further comprises a production location where the agricultural commodity is produced.

10. The method of claim 9, further comprising:
receiving weather data for the production location;
generating weather information using the weather data for the production location; and
sending the weather information to the seller mobile device using SMS format, wherein the weather information is used to assist the seller in producing the agricultural commodity.

11. The method of claim 1, further comprising:
receiving, from the primary buyer mobile device, revised buyer criteria from the plurality of buyer criteria, wherein the revised buyer criteria comprises at least one selected from a group consisting of a revised buyer price and a revised purchase quantity; and
upon receiving the revised buyer criteria, sending the revised buyer criteria to the seller mobile device using SMS format.

12. The method of claim 1, further comprising:
receiving viability data corresponding to production of the agricultural commodity;
generating viability information using the viability data; and
sending the viability information corresponding to the production of the agricultural commodity to the seller mobile device using SMS format.

13. The method of claim 12, wherein the viability information comprises at least one selected from a group consisting of information about a disease effecting the agricultural commodity, instructions for combating the disease, instructions for increasing production of the agricultural commodity, and a suggestion to produce a different agricultural commodity based on the seller criteria and the viability information.

14. The method of claim 1, wherein the predetermined period of time in which to match each of the plurality of buyers with the seller is twenty four hours.

15. The method of claim 1, wherein each of the plurality of locations at which to sell the agricultural commodity is within 100 kilometers of the land used to produce the agricultural commodity.

16. The method of claim 1, wherein each of the plurality of buyer criteria further comprises a quantity category defined by a range of purchase quantities, and wherein the plurality of seller criteria further comprises a yield category defined by a range of yields, wherein matching each of the plurality of buyers with the seller is further based on the quantity category falling within the yield category.

17. The method of claim 16, wherein the number of buyers is directly proportional to the range of purchase quantities for the quantity category.

18. A method for matching a seller to a buyer for transacting an agricultural commodity, the method comprising:
sending, using a seller mobile device, seller criteria for the agricultural commodity, wherein the seller criteria comprises a sales quantity, a yield from an area of land used to produce the agricultural commodity, and a plurality of locations at which to sell the agricultural commodity;
within a predetermined period of time after sending the seller criteria, receiving a plurality of buyer criteria on the mobile device in short message service (SMS) format, based on determining that the yield is sufficient to meet a purchase quantity and a transaction location at which to sell the agricultural commodity falls within the plurality of locations,
wherein each of the plurality of buyer criteria is sent from a mobile device used by one of a plurality of buyers of the agricultural commodity,
wherein each of the plurality of buyer criteria comprises the purchase quantity, a buyer price, and the transaction location at which to buy the agricultural commodity, and
wherein the plurality of buyers comprises a primary buyer and a secondary buyer;
evaluating each of the plurality of buyer criteria;
selecting a buyer criteria of the primary buyer from the plurality of buyer criteria; and
contacting, using the seller mobile device, the primary buyer using contact information provided by the primary buyer to execute the transaction of the agricultural commodity at a primary transaction price based on the buyer criteria of the primary buyer.

19. The method of claim 18, further comprising, after contacting the primary buyer and being unable to execute the transaction, contacting, using the mobile device, the secondary buyer using the contact information provided by the secondary buyer to execute the transaction of the agricultural commodity at a secondary transaction price based on the buyer criteria of the secondary buyer.

20. The method of claim 18, further comprising:
receiving a history of transaction prices for the agricultural commodity, the history of transaction prices comprising the transaction price and a plurality of previously executed transaction prices.

21. The method of claim 20, wherein the history of transaction prices for the agricultural commodity is based on the transaction location.

22. The method of claim 20, further comprising:
receiving a forecast transaction price at the transaction location based on the history of transaction prices.

23. The method of claim 18, wherein the agricultural commodity is a crop produced by the seller.

24. The method of claim 18, wherein each of the plurality of buyer criteria and the seller criteria include a predetermined range of time in which to execute the transaction.

25. The method of claim 18, wherein the seller criteria further comprises a location where the agricultural commodity is produced.

26. The method of claim 25, further comprising:
receiving weather information on the mobile device, wherein the weather information used to assist the seller in producing the agricultural commodity for the location.

27. The method of claim 18, further comprising:
receiving revised buyer criteria associated with the primary buyer, wherein the revised buyer criteria comprises at least one selected from a group consisting of a revised buyer price and a revised purchase quantity; and
upon receiving the revised buyer criteria, contacting, using the mobile device, the primary buyer using the contact information provided by the primary buyer to execute a revised primary transaction of the agricultural commodity at a revised primary transaction price based on the revised buyer criteria.

28. The method of claim 18, further comprising:
receiving, on the seller mobile device, viability information corresponding to the production of the agricultural commodity.

29. The method of claim 28, wherein the viability information comprises at least one selected from a group consisting of information about a disease effecting the agricultural commodity, instructions for combating the disease, instructions for increasing production of the agricultural commodity, and a suggestion to produce a new agricultural commodity based on the seller criteria and the viability information.

30. The method of claim 18, wherein each of the plurality of buyer criteria further comprises a quantity category defined by a range of purchase quantities and wherein the plurality of seller criteria further comprises a yield category defined by a range of yields, wherein matching each of the plurality of buyers with the seller is further based on the quantity category falling within the yield category.

31. The method of claim 30, wherein the number of buyers is directly proportional to the purchase quantities of the purchase category.

32. A system for matching parties to a transaction of an agricultural commodity comprising:
a storage repository configured to store seller criteria and a plurality of buyer criteria;
a processor of a central server configured to access the storage repository and execute software instructions stored in memory for:
receiving a plurality of buyer criteria, wherein each of the plurality of buyer criteria is sent from a mobile device used by one of a plurality of buyers of the agricultural commodity,
wherein the plurality of buyers comprises a primary buyer and a secondary buyer, and
wherein each of the plurality of buyer criteria comprises a purchase quantity, a buyer price, and a transaction location at which to buy the agricultural commodity;
receiving seller criteria for the agricultural commodity sent from a seller mobile device, wherein the seller criteria comprises a sales quantity, a yield from an area of land used to produce the agricultural commodity, and a plurality of locations at which to sell the agricultural commodity;
matching, within a predetermined period of time after receiving the plurality of buyer criteria and the seller criteria, each of the plurality of buyers with the seller based on determining that the yield is sufficient to meet the purchase quantity and the transaction location at which to buy the agricultural commodity falls within the plurality of locations; and
sending the plurality of buyer criteria to the seller mobile device using short message service (SMS) format.

33. A computer readable medium comprising instructions executable by a processor to perform a method for matching parties to a transaction of an agricultural commodity, the method comprising:
receiving a plurality of buyer criteria, wherein each of the plurality of buyer criteria is sent from a mobile device used by one of a plurality of buyers of the agricultural commodity,
wherein the plurality of buyers comprises a primary buyer and a secondary buyer, and
wherein each of the plurality of buyer criteria comprises a purchase quantity, a buyer price, and a transaction location at which to buy the agricultural commodity;
receiving seller criteria for the agricultural commodity sent from a seller mobile device, wherein the seller criteria comprises a sales quantity, a yield from an area of land used to produce the agricultural commodity, and a plurality of locations at which to sell the agricultural commodity;
matching, within a predetermined period of time after receiving the plurality of buyer criteria and the seller criteria, each of the plurality of buyers with the seller based on determining that the yield is sufficient to meet the purchase quantity and the transaction location at which to buy the agricultural commodity falls within the plurality of locations; and
sending the plurality of buyer criteria to the seller mobile device using short message service (SMS) format.

34. The computer readable medium of claim 33, wherein the seller, using the seller mobile device, selects a buyer criteria of the primary buyer from the plurality of buyer criteria and contacts the primary buyer using contact information provided by the primary buyer to execute the transaction of the agricultural commodity at a transaction price based on the buyer criteria of the primary buyer.

35. The computer readable medium of claim 34, wherein the seller is unable to execute the transaction with the primary buyer and, using the seller mobile device, contacts the secondary buyer using contact information provided by the secondary buyer to execute the transaction of the agricultural commodity at a transaction price based on a buyer criteria of the secondary buyer upon selecting the buyer criteria of the secondary buyer from the plurality of buyer criteria.

36. A computer readable medium comprising instructions executable by a processor to perform a method for matching a seller to a buyer for transacting an agricultural commodity, the method comprising:
sending, using a mobile device, seller criteria of the agricultural commodity, the seller criteria comprising a sales quantity, a category, and a plurality of locations at which to sell the agricultural commodity, wherein the plurality of locations comprises the location from each of the plurality of buyer criteria, and wherein the category comprises the one of the plurality of ranges corresponding to an area of land used to produce the agricultural commodity;
within a predetermined period of time of sending the seller criteria, receiving on the mobile device in short message service format, based on matching to the seller criteria, a plurality of buyer criteria associated with a plurality of buyers, wherein each of the plurality of buyer criteria comprises contact information, the category, a buyer price, and a location at which to buy the agricultural commodity, wherein the plurality of buyers comprises a primary buyer and a secondary buyer, wherein the category comprises one of a plurality of a ranges corresponding to a purchase quantity, and wherein matching to the seller criteria comprises matching each of the plurality of buyers with the seller based on the category and the plurality of locations;
evaluating each of the plurality of buyer criteria;
selecting buyer criteria associated with the primary buyer; and
contacting, using the mobile device, the primary buyer using the contact information to execute the transaction of the agricultural commodity at a transaction price based on the buyer criteria of the primary buyer.

37. The computer readable medium of claim 36, further comprising, after contacting the primary buyer and being unable to execute the transaction, contacting, using the mobile device, the secondary buyer using the contact information to execute the transaction of the agricultural commodity at a transaction price based on the buyer criteria of the secondary buyer.
